(19) United States
(12) Patent Application Publication
(10) Pub. No.: US 2014/0035976 A1
(43) Pub. Date: Feb. 6, 2014

(54) EJECTOR WITH IMPROVED JETTING LATENCY FOR HIGH SOLIDS CONTENT

(71) Applicants: James West Blease, Avon, NY (US); Christopher Newell Delametter, Rochester, NY (US); Thomas B. Brust, Webster, NY (US); David Paul Trauernicht, Rochester, NY (US); John Andrew Lebens, Rush, NY (US)

(72) Inventors: James West Blease, Avon, NY (US); Christopher Newell Delametter, Rochester, NY (US); Thomas B. Brust, Webster, NY (US); David Paul Trauernicht, Rochester, NY (US); John Andrew Lebens, Rush, NY (US)

(21) Appl. No.: 13/562,347

(22) Filed: Jul. 31, 2012

(51) Int. Cl. B41J 29/38; B41J 2/05

(52) U.S. Cl. 347/9; 347/56

(57) ABSTRACT

A liquid ejection system includes a liquid ejector having a structure defining a chamber, the chamber including a first surface and a second surface, the first surface including a nozzle orifice; a resistive heater located on the second surface of the chamber opposite the nozzle orifice; a first liquid feed channel and a second liquid feed channel being in fluid communication with the chamber; and a segmented liquid inlet, a first segment of the liquid inlet being in fluid communication with the first liquid feed channel, and a second segment of the liquid inlet being in fluid communication with the second liquid feed channel; and a liquid supply comprising a liquid including a carrier fluid and a solids content that is greater than 5 percent by weight, wherein the liquid supply is fluidically connected to the segmented liquid inlet.

### FIELD OF THE INVENTION

The invention relates generally to the field of liquid ejection systems, and in particular to ejection using a type of thermal inkjet ejector having greatly improved reliability for drop ejection of liquids that have poor latency using conventional thermal inkjet ejectors.

### CROSS REFERENCE TO RELATED APPLICATIONS

Reference is made to commonly assigned, co-pending U.S. patent application Ser. No. ______ (K001189), concurrently filed herewith, entitled “Ejector with Improved Jetting Latency for High Molecular Weight Polymers” by Thomas Brust, et al.; and co-pending U.S. patent application Ser. No. ______ (K001190), concurrently filed herewith, entitled “Method of Printing with High Solids Content Ink” by Christopher Delametter, et al., the disclosures of which are herein incorporated by reference.

### BACKGROUND OF THE INVENTION

Drop on demand liquid ejection systems include a liquid supply fluidically connected to a liquid ejector that is capable of ejecting individual droplets of the liquid as needed. A familiar type of drop on demand liquid ejection system is an inkjet printer, where liquid ink is provided to an ejector, such as a piezoelectric ejector or a resistive heater ejector. Other types of liquid ejection systems are used for precise metering of liquids, or patternwise deposition of liquids in non-imaging applications, for example, to form electronic or optical devices or structural members.

A piezoelectric ejector includes a chamber for holding a small quantity of liquid and one or more piezoelectric elements, which change the volume of the chamber when an electrical pulse is applied in order to eject a droplet through a nozzle associated with the chamber. A resistive heater ejector includes a chamber holding a small quantity of liquid and a resistive heater in contact with the liquid. When an electrical pulse is applied to the resistive heater, the heater and the liquid near the heater are heated up so that a portion of the liquid is vaporized, forming an expanding bubble that propels a droplet of liquid through a nozzle associated with the chamber. Resistive heater ejectors (which are used in thermal inkjet printheads) have advantages of simple and economical fabrication at high ejector resolution, but they typically do not have as wide a latitude for jetting different types of liquids as piezoelectric ejectors.

Liquids in liquid ejection systems typically include a material of interest and a carrier fluid. In an inkjet printing system, the material of interest is typically a colorant, and the carrier fluid is typically water-based. Additional components are included in an ejectable liquid for reliable jetting or to promote desirable properties of the ejected droplets, including their interaction with a medium onto which they are ejected.

For printing applications, ink compositions containing colorants used in inkjet printers can be classified as either pigment-based, in which the colorant exists as pigment particles suspended in the ink composition, or as dye-based, in which the colorant exists as a fully solvated dye species that consists of one or more dye molecules. Pigments are highly desirable since they are far more resistant to fading than dyes. However, pigment inks can have inferior durability after printing, especially under conditions where abrasive forces have been applied to the printed image and especially at short time intervals from immediately after printing to several minutes while the inks are drying.

Pigment-based inks must be reliably ejected from a printhead for numerous individual firing events during the lifetime of a printer. This includes situations where the printhead is left idle or uncapped for long periods of time and then is actuated again to eject ink. In some instances, the idle printhead nozzles can partially clog or crust with ink components thereby degrading the ability of the printhead to eject properly. For example, the ink can be misdirected from the partially clogged nozzles or the drop velocity can be greatly diminished. In some instances, a nozzle can become permanently clogged and in other instances a lengthy and costly maintenance operation may be required to recover the nozzle back to a usable state of operation. This phenomenon is known in the art of inkjet printing as latency or decap. An ink having good latency performance will exhibit a useful drop velocity after long decap intervals. A longer latency is highly desirable as the ink can reside in the idle printhead for a longer time without adversely affecting the ink ejection performance. Inkjet printers typically include a cap or other reservoir for ejecting maintenance droplets periodically, so that droplets ejected as part of an image will be reliably and accurately ejected for good image quality. Printing throughput is adversely affected if it is required to eject maintenance droplets too frequently.

Formulation of ejectable liquids, such as inkjet inks, involves balancing desirable jetting properties of the liquid through the associated liquid ejector with properties of the material of interest in the ejected droplets. For example, in a pigment-based ink, polymeric dispersants can be added to keep the pigments in suspension in the carrier fluid, and polymeric binders can be added to improve durability of an image on a recording medium onto which the droplets have been ejected.

Pigment-based inks formulated with polymeric dispersants and binders can be difficult to jet through inkjet printheads having small nozzle diameters especially by the thermal inkjet printing process. This is especially true of pigment-based inks, which are formulated with humectants or penetrants that lower dynamic surface tension. In recent years, thermal inkjet printers have moved to higher jetting frequencies to provide faster printing speeds. Thermal inkjet printers are now capable of printing at jetting frequencies in excess of 10 kHz. However, this high frequency firing can come at the cost of variability in the drop velocity, which can lead to poor image quality in the final printed image.

Polyurethane binders have been used as durability enhancing additives in dye-based and pigment-based inkjet inks. U.S. Pat. No. 6,136,890 discloses a pigment-based inkjet ink wherein the pigment particles are stabilized by a polyurethane dispersant. U.S. Patent Application 2004/0242726 discloses a pigment dispersed by a cross-linking step between a resin having a urethane bond and a second water-soluble polymer. U.S. Patent Application 2004/0229976 discloses polyurethane/polyurea resins for pigmented inks where the weight fraction of a polyurethane urea part is at most 2.0 wt % to the urethane resin.

Although polyurethanes are known for their excellent durability, they also have a number of drawbacks. For example, not all polyurethane polymers are conducive to jetting from a thermal inkjet head. In particular, water-dispersible polyurethane particles, such as those disclosed in U.S. Pat. Nos. 6,533,408 and 6,268,101, Statutory Invention Registration U.S. H2113H, and published U.S. Patent Applications 2004/0130608 and 2004/0229976 are particularly difficult to jet from a thermal inkjet printhead at high firing frequencies. The molecular weight of the polyurethane binder plays an important role in the ink performance and durability of the resulting printed images. For example, molecular weights below about 8,000 generally do not provide highly durable images. On the other hand, molecular weights above about 20,000 can be detrimental to firing performance from a thermal inkjet printhead, especially for inks having high solids content, i.e. a content of more than about 5% by weight of pigment particles and polymers. The acid number of the polyurethane or other binder polymer also creates limitations for use in an inkjet printing system. If the acid number of the binder polymer is too high the resulting abrasion resistance of the image can become degraded, especially under conditions of high temperature and high humidity. If the acid number of the binder polymer is too low, a substantial amount of particulate polymer will exist and jetting can become degraded.

Both the ejector design and the liquid formulation have an impact on the latency, i.e. on how long a time interval between ejecting droplets through an ejector can be while still providing reliable ejection of the next droplet. In the context of inkjet printing, it is desired to provide deposited drops on the recording medium having small spot size of uniform pigment loading to reduce image graininess, high intensity of color for wide color gamut, fade resistance, and good adhesion to the recording medium. It is also important to provide interaction between the ejected ink and the recording medium, without causing undesirable changes, such as extensive curling, in the recording medium after printing. For jetting reliability, it is important to keep the viscosity at a sufficiently low level, enable high frequency ejection, and provide long latency. It can be difficult to provide desirable marking and jetting properties, particularly for a printhead having small nozzles, and for liquids having high solids content or high molecular weight polymers.

### Problem to be Solved by the Invention

Although the use of pigments and polymer binders have found use in liquid ejection systems such as inkjet printers, there remains the need to identify an resistive heater ejector design that is capable of providing a greater latitude for ejecting inks or other liquids having desirable properties over the required range of operating conditions. This is especially true for inks or other liquids having high solids content above about 5 percent by weight, as well as for inks or other liquids including a significant loading of polymers having high molecular weight. It is therefore an object of this invention to identify a liquid ejector design having a demonstrated significant improvement in latency relative to conventional liquid ejectors that have poor latency for ejecting such liquids having high solids content or significant loading of polymers having high molecular weight

### SUMMARY OF THE INVENTION

A liquid ejection system comprising: a liquid ejector comprising: a structure defining a chamber, the chamber including a first surface and a second surface, the first surface including a nozzle orifice; a resistive heater located on the second surface of the chamber opposite the nozzle orifice; a first liquid feed channel and a second liquid feed channel being in fluid communication with the chamber; and a segmented liquid inlet, a first segment of the liquid inlet being in fluid communication with the first liquid feed channel, and a second segment of the liquid inlet being in fluid communication with the second liquid feed channel; and a liquid supply comprising a liquid including a carrier fluid and a solids content that is greater than 5 percent by weight, wherein the liquid supply is fluidically connected to the segmented liquid inlet.

### BRIEF DESCRIPTION OF THE DRAWINGS

In the detailed description of the preferred embodiments of the invention presented below, reference is made to the accompanying drawings, in which:

FIG. 1 is a schematic representation of a liquid ejection system incorporating a dual feed liquid ejector;

FIGS. 2A and 2B are schematic top views of a portion of a dual feed liquid ejection printhead die;

FIG. 3 is a schematic top view of a portion of another dual feed liquid ejection printhead;

FIG. 4 is a schematic top view of a portion of still another dual feed liquid ejection printhead die;

FIG. 5 is a schematic cross sectional view of one dual feed liquid ejector shown through line 5-5 of FIG. 4;

FIG. 6 is a schematic top view of a portion of yet another dual feed liquid ejection printhead die;

FIG. 7 is a schematic top view of a portion of still yet another dual feed liquid ejection printhead die;

FIG. 8 is a lower magnification of a portion of a dual feed liquid ejection printhead die;

FIG. 9 is a perspective of a portion of a printhead;

FIG. 10 is a perspective of a portion of a carriage printer; and

FIG. 11 is a schematic side view of an exemplary paper path in a carriage printer.

### DETAILED DESCRIPTION OF THE INVENTION

### Dual Feed Liquid Ejector

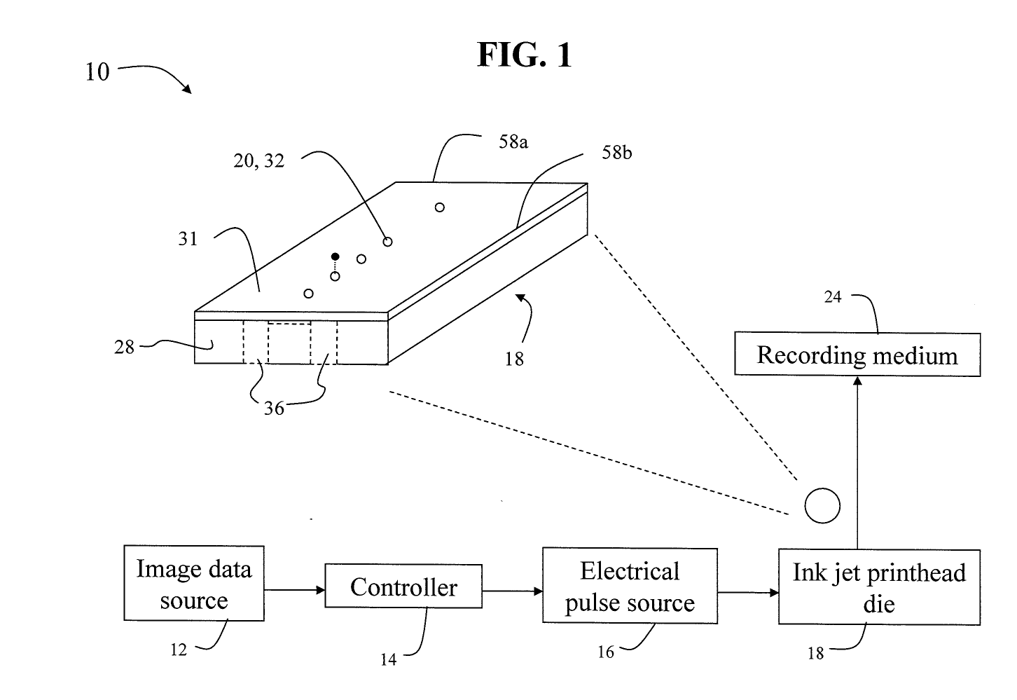

U.S. Pat. No. 7,857,422, incorporated by reference herein in its entirety, discloses a dual feed liquid drop ejector, some configurations of which are described below relative to FIGS. 1-8.

Referring to FIG. 1, a schematic representation of a liquid ejection system 10, for example, an inkjet printer, is shown. The liquid ejection system 10 includes an image data source 12 (for example, image data) which provides signals that are interpreted by a controller 14 as being commands to eject liquid drops. The controller 14 outputs signals to a source 16 of electrical energy pulses which are sent to a liquid ejection printhead die 18. A liquid supply (not shown) is fluidically connected to a segmented liquid inlet 36. The liquid ejection printhead die 18 includes a plurality of dual feed liquid ejectors 20 (described below) arranged in at least one array, for example, a substantially linear row. During operation, liquid from the liquid supply, for example, ink in the form of ink drops, is deposited on a recording medium 24.

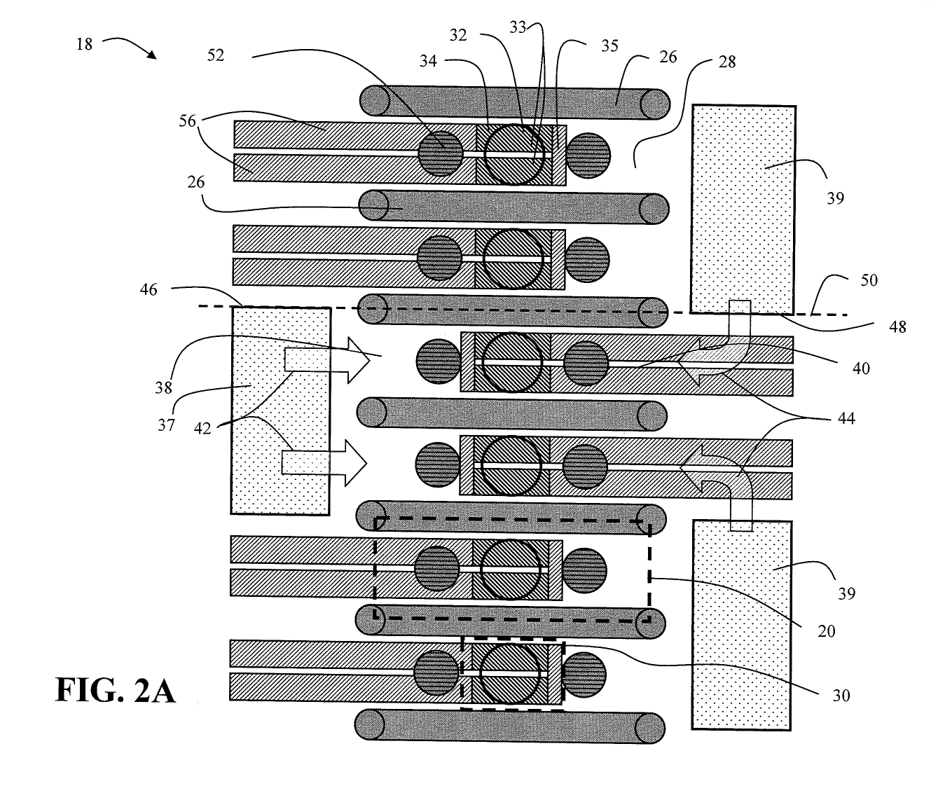

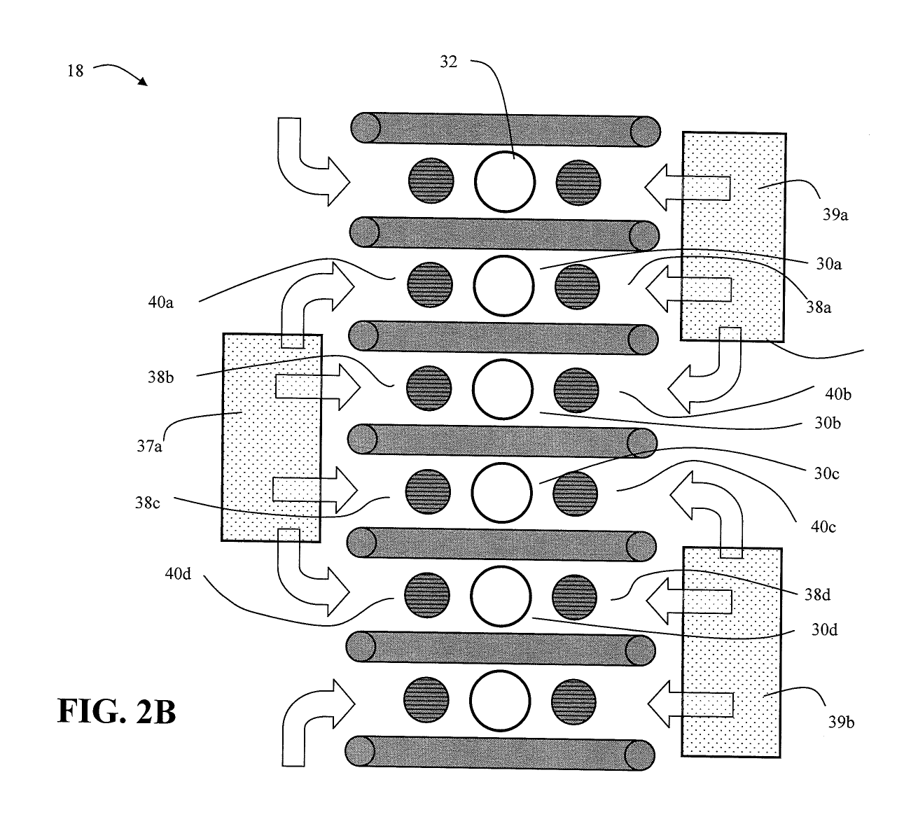

Referring to FIGS. 1 and 2A, a schematic representation of the liquid ejection printhead die 18 is shown. The liquid ejection printhead die 18 includes an array or plurality of dual feed liquid ejectors 20. The dual feed liquid ejector 20 includes a structure, for example, walls 26 extending from a substrate 28 that define a chamber 30. The walls 26 separate the dual feed liquid ejectors 20 positioned adjacent to other dual feed liquid ejectors 20. Each chamber 30 includes a nozzle orifice 32 in a nozzle plate 31 through which liquid is ejected. A resistive heating element 34, which functions as a drop forming element, is also located in each chamber 30. In FIG. 2A, the resistive heating element 34 is positioned on a top surface of the substrate 28 in a bottom of the chamber 30 and opposite the nozzle orifice 32, although other configurations are permitted. In other words, in this embodiment the bottom surface of the chamber 30 is the top of the substrate 28, and the top surface of the chamber 30 is the nozzle plate 31.

Referring to FIGS. 1, 2A, and 2B a segmented liquid inlet 36 supplies liquid to each chamber 30 through first and second liquid feed channels 38 and 40 that are in fluid communication with each chamber 30. The segmented inlet 36 includes a first segment 37 that is in fluid communication with first liquid feed channel 38 and a second segment 39 that is in fluid communication with the second liquid feed channel 40. The first segments 37 and the second segments 39 are positioned on opposite sides of the chamber 30 and the nozzle orifice 32.

In FIGS. 2A and 2B, each first segment 37 of the segmented liquid inlet 36 and each second segment 39 of the segmented liquid inlet 36 are positioned offset relative to each other as viewed from a plane perpendicular to a plane including the nozzle orifice 32 (the view shown in FIGS. 2A and 2B). Positioning the first segment 37 and the second segment 39 in this manner enables a segment (either the first segment 37 or the second segment 39) to provide liquid to the chambers 30 that are aligned with the first segment 37 (represented by liquid flow arrows 42) as well as provide liquid to the chambers 30 that are offset from the second segment 39 (represented by liquid flow arrows 44). In FIG. 2A, each of the first segment 37 and the second segment 39 supply liquid to the two chambers 30 that are aligned with or located across from each segment 37, 39. Additionally, each of the first segment 37 and the second segment 39 supply liquid to the chambers 30 on either side of each segment 37, 39 that are offset from or located adjacent to each segment 37, 39.

The flow patterns of FIG. 2A are further clarified in FIG. 2B, where some structural elements are omitted for simplification. Individual chambers 30a, 30b, 30c and 30d are designated, as are first segment 37a and second segments 39a and 39b of the segmented liquid inlet 36. In the description below, a liquid feed channel feeding a particular chamber is referenced. It should be understood that this means that this channel primarily feeds the specified chamber (typically a nearby neighbor chamber). However, the channel also feeds other nearby chambers to a lesser extent, depending on flow requirements due to jet firing patterns. First liquid feed channel 38a feeds chamber 30a from second segment 39a of segmented liquid inlet 36. In addition, second liquid feed channel 40a also feeds chamber 30a from first segment 37a, which is offset from and adjacent to chamber 30a. Both chambers 30b and 30c are fed by first liquid feed channels 38b and 38c respectively from first segment 37a of segmented liquid inlet 36. Chamber 30b is also fed by second liquid feed channel 40b from second segment 39a, while chamber 30c is also fed by second liquid feed channel 40c from second segment 39b. Chamber 30d is fed by first liquid feed channel 38d from second segment 39b, and is also fed by second liquid feed channel 40d from first segment 37a. Each chamber 30 is fed by the first liquid feed channel 38 from a segment 37 or 39 of the segmented liquid inlet 36 that is directly in line with the chamber 30, and also by the second liquid feed channel 40 from a segment 39 or 37 of the segmented liquid inlet 36 that is offset somewhat from the chamber 30.

An important aspect of the dual feed liquid ejector 20 is that each chamber 30 is supplied with liquid by the first liquid feed channel 38 that is connected to a segment 37 or 39 of the segmented liquid inlet 36 located on one side of the chamber 30, and by the second liquid feed channel 40 that is connected to a segment 39 or 37 of the segmented liquid inlet 36 located on the opposite side of the chamber 30. That is different from a conventional liquid ejector (not shown) having a chamber that is bounded typically on three sides by walls, with the fourth side being open and facing a single ink inlet.

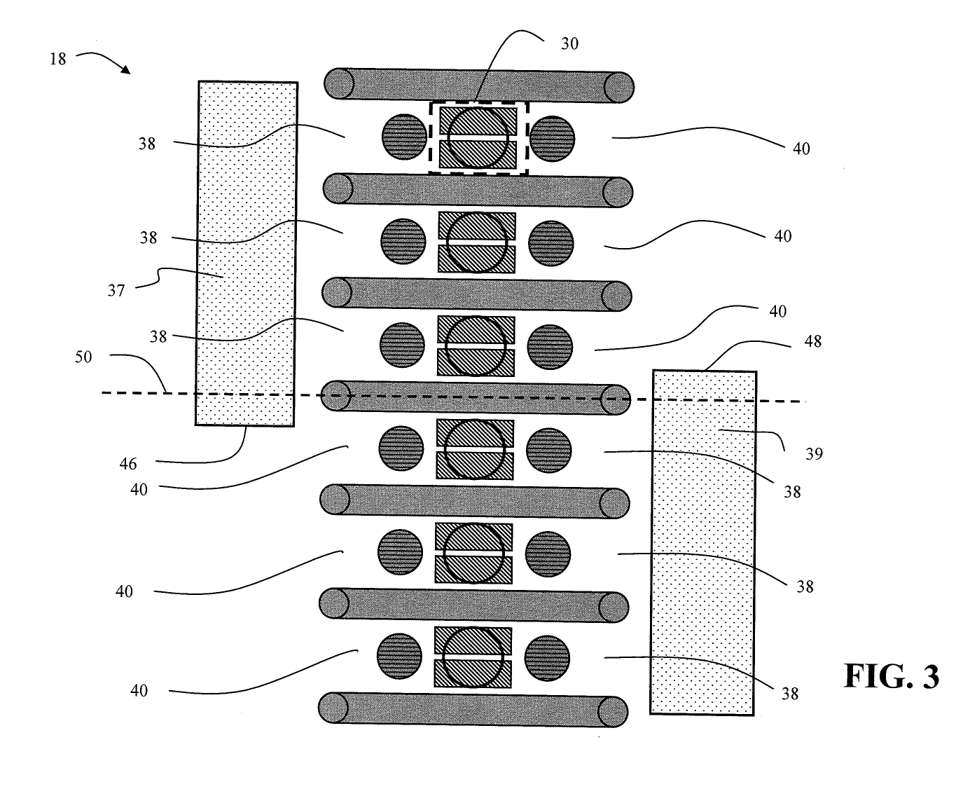

In FIGS. 2A and 2B, the first and second segments 37 and 39 of the segmented liquid inlet 36 are each approximately as wide as the two adjacent chambers 30, and the spacing between adjacent second segments 39a and 39b is also approximately as wide as the two adjacent chambers 30. In other words, the two chambers 30 are fed by the first liquid feed channels 38 from segments 37 or 39 of the segmented liquid inlet 36 that are directly in line with the chambers 30, and the second feed channels 40 for these two chambers are from segments 39 or 37 that are offset somewhat from the chambers 30. Other configurations are possible. For example, FIG. 3 shows the case of more than the two chambers 30 (i.e. 3, 4, or more chambers) being fed by the first liquid feed channels 38 from segments 37 or 39 of the segmented liquid inlet 36 that are directly in line with the chambers 30, and also by the second liquid feed channels 40 from segments 39 or 37 of the segmented liquid inlet 36 that are somewhat offset from the chambers 30.

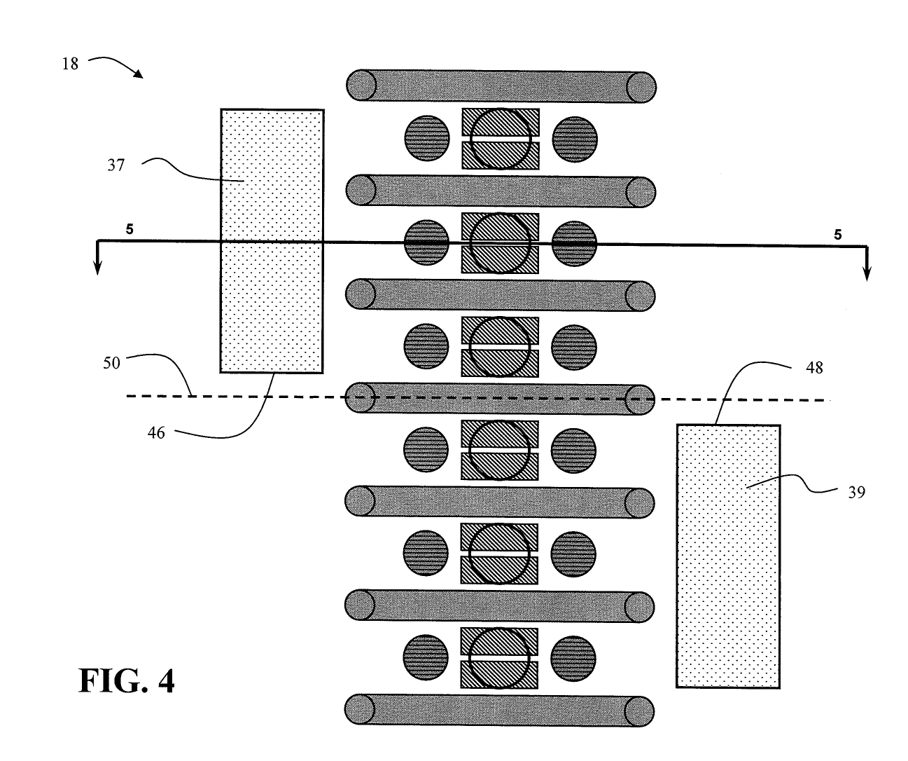

Each first segment 37 of the segmented liquid inlet 36 includes ends 46 that are substantially in line with ends 48 of each second segment 39 of the segmented liquid inlet 36. In FIG. 2A, the end 46 of first segment 37 is aligned with the end 48 of the second segment 39 represented by a dashed line 50. However, other configurations are permitted. For example, the ends 46 and 48 can overlap each other as is shown in FIG. 3. Alternatively, the ends 46 and 48 can be positioned spaced apart from each other as is shown in FIG. 4.

One or more posts 52 can be disposed in the chamber 30, the first liquid feed channel 38, the second liquid feed channel 40, or combinations thereof. As discussed in more detail below, the posts 52 can be symmetrically or asymmetrically disposed about the nozzle orifice 32 and within one or both of the liquid feed channels 38, 40. The posts 52 can have the same cross sectional area or different cross sectional areas when compared to each other. The posts 52 can also have same shapes or different shapes when compared to each other.

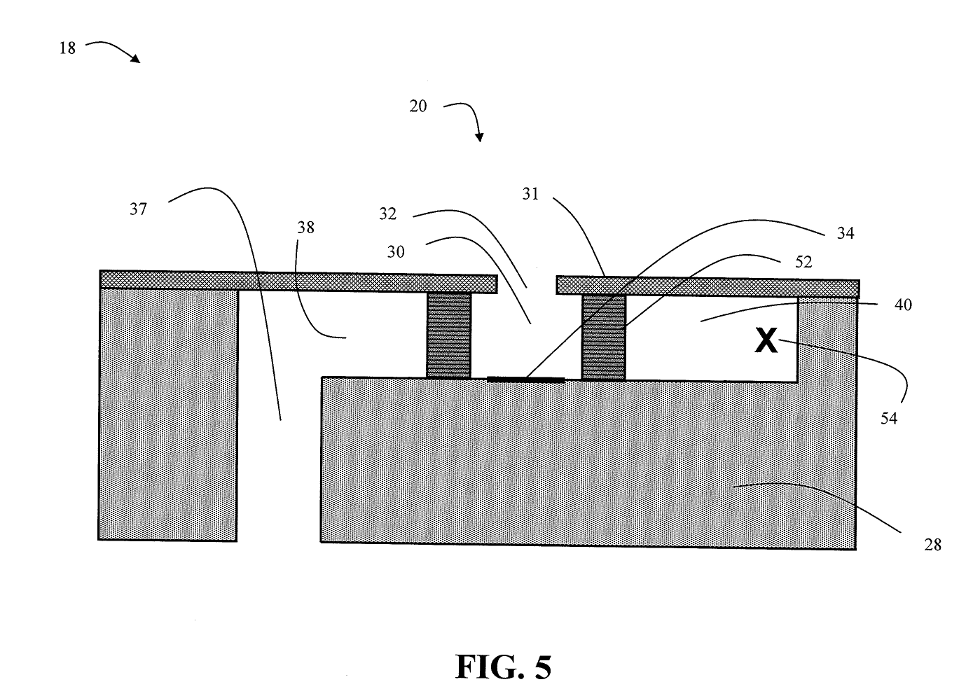

Referring to FIG. 5, a schematic cross sectional view of one dual feed liquid ejector 20 is shown through line 5-5 of FIG. 4. The dual feed liquid ejector 20 includes the chamber 30 connected in fluid communication with the first liquid feed channel 38 which is connected in fluid communication to one of a plurality of the first segments 37 of the segmented liquid inlet 36. The chamber 30 is also connected in fluid communication with the second liquid feed channel 40 which is connected in fluid communication to one of a plurality of the second segments 39 of the segmented liquid inlet 36. In FIG. 5, the first segment 37 of the segmented liquid inlet 36 is aligned with the chamber 30 and supplies liquid directly to the chamber 30. The second segment 39 of the segmented liquid inlet 36 is offset relative to the chamber 30 and supplies liquid indirectly to the chamber 30 (represented by “X” 54). The resistive heating element 34 is located in the chamber 30 and is operable to eject liquid through the nozzle orifice 32. The posts 52 are also present in the chamber 30 and one or both of the first and second liquid feed channels 38 and 40.

Having described the basic components of the dual feed liquid ejector 20, the operation of a dual feed liquid ejector 20, as embodied in a thermal inkjet printhead, will be described so that the advantages and reasons for those advantages become more apparent. Ink enters the printhead die 18 through the segmented liquid inlet 36 and passes through the first and second liquid feed channels 38 and 40 from opposite directions to enter the fluid chamber 30. In a conventional thermal inkjet printhead, the chamber 30 is filled with ink through a single liquid feed channel from only one direction. When the chamber 30 of the dual feed liquid ejector 20 is filled with ink, the resistive heating element 34, which is positioned below the nozzle orifice 32, is in thermal contact with the pool of ink in the chamber 30. A particular configuration of the resistive heating element 34 is shown that includes two parallel legs of a resistive material 33, joined at one end by a conductive shorting bar 35. Electrical leads 56 are connected to each leg 33 at the opposite end from the shorting bar 35. However, other configurations of the resistive heating element 34 are possible.

With reference to FIG. 1, when the image data source 12 provides a signal that is interpreted by the controller 14 as a command for a drop of ink to be ejected from a particular chamber 30 at a particular time, the electrical pulse source 16 provides an electrical pulse to the heater 34 through the electrical leads 56. The pulse voltage is chosen such that a bubble is nucleated in the superheated ink over the heater. As the bubble grows, it pushes the ink above it out through the nozzle orifice 32, thus ejecting a drop. The size of the droplet (i.e. its volume or mass, which is related to the size of the dot produced on recording medium 24) is determined primarily by size of the heater 34, size of the nozzle 32, and geometry of the chamber 30, and to a lesser extent on ink temperature and pulse configuration.

For accurate firing of jets, it is preferable for the droplet to be ejected at a velocity of approximately 6 to 20 meters per second, depending somewhat on the size of the droplet. In order to increase the drop velocity (and increase the energy efficiency, which is the energy of the drop divided by the energy input into the resistive heating element 34), it is helpful to preferentially direct the expansion of the bubble toward the nozzle. This is one of the functions of the posts 52, which act as a source of lateral fluid impedance, so that a greater amount of the bubble expansion is directed toward the nozzle orifice 32.

The posts 52 also restrict the amount and momentum of liquid flow away from the chamber 30, so that the refill of the chamber 30 is able to occur more quickly. Refill of the chamber 30 is typically the rate limiting step for how quickly the same chamber can be fired again. After the drop is ejected, liquid must feed in from the segmented liquid inlet 36 through the first and second liquid feed channels 38 and 40 and into the chamber 30. The dual feed configuration inherent in this invention increases refill rate (and hence printing throughput speeds) for several reasons. As mentioned above, the posts 52 restrict the backflow of ink so that the reversal of ink flow can happen more quickly. Another important factor promoting faster refill is the existence of the two liquid feed channels 38 and 40 rather than a single feed channel, thereby increasing the rate of flow of ink back into the chamber 30. In addition, compared to conventional liquid ejectors, which are fed from one side of the chamber 30, but have a fluidic dead-end at the opposite side of the chamber 30, the dual feed liquid ejector 20 described herein is fed from two opposite sides of the chamber 30. As a result, the ink-air interface possesses symmetric curvature relative to the chamber 30 during refill, which enhances the pressure differences that drive refill, so that refill occurs more rapidly. Computer simulations of flow, as well as testing of the dual feed configuration indicate that refill rate is approximately twice as high as for a conventional single feed configuration for a comparably sized drop.

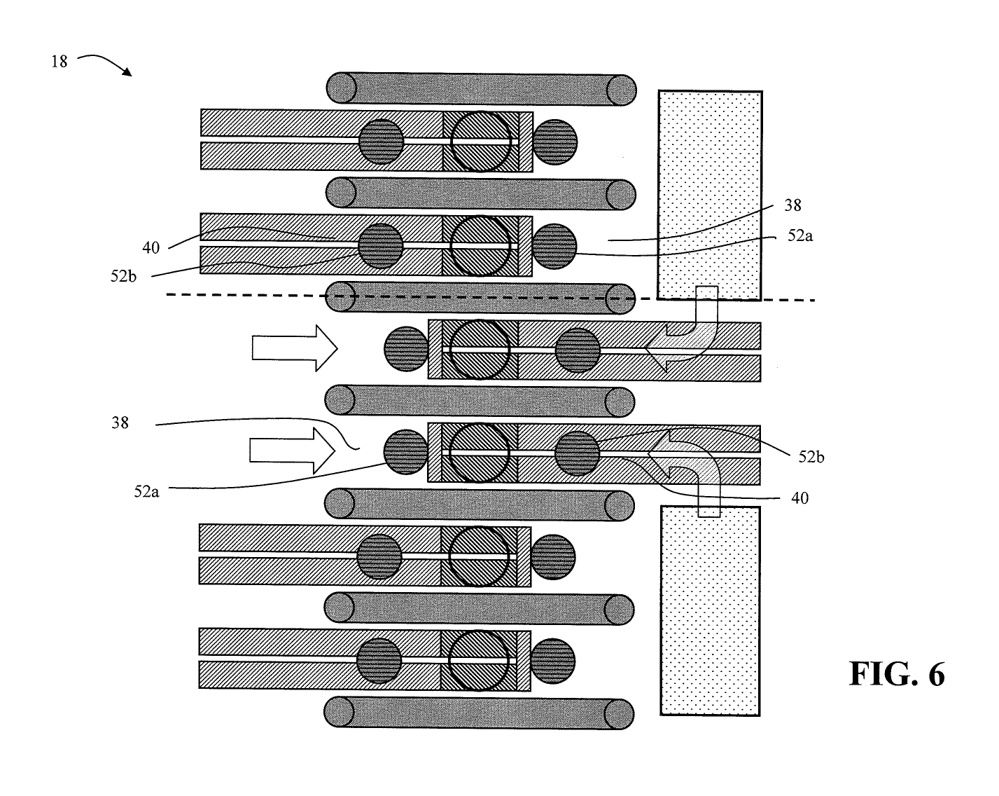

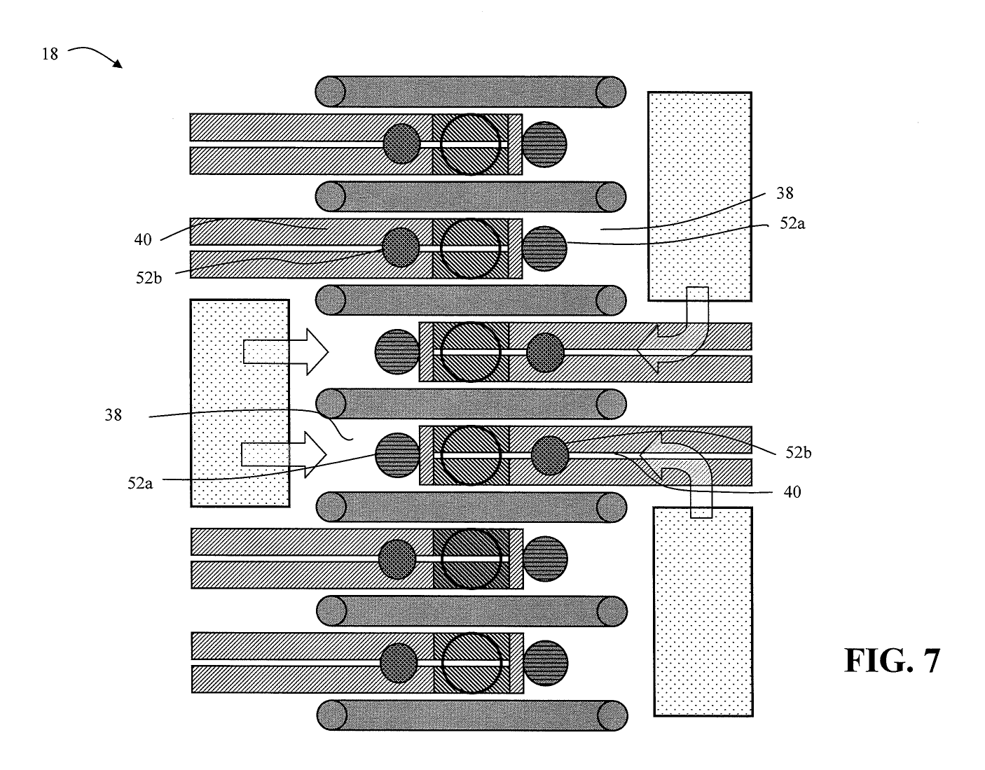

As can be seen in FIGS. 2A and 2B, the first segment 37 of the segmented inlet 36 feeds the first liquid feed channel 38 which is directly in front of the first segment 37. The second segment 39 feeds the second liquid feed channel 40 which is offset from the second segment 39. Due to the different fluid path lengths, there is an inherent difference between fluid impedances from the segment 37 and the first liquid feed channel 38 to the chamber 30, as compared with the fluid impedance from the segment 39 and the second liquid feed channel 40. Therefore, in some embodiments, the position or cross-sectional area of one or more posts may be modified to compensate for this difference in fluid impedance. For example, in FIG. 6, post 52b in the second liquid feed channel 40 is moved further away from the nozzle orifice 32 than post 52a is in the second liquid feed channel 38. Similarly, in FIG. 7, post 52b in the second liquid feed channel 40 is formed with a smaller cross-sectional area than post 52a in the feed channel 38. FIGS. 6 and 7 show all posts 52a in the first liquid feed channels 38 being located similarly to one another and with a first same cross-sectional area, and similarly all posts 52b in the second liquid feed channels 40 being located similarly to one another and with a second same cross-sectional area. However, it may be understood, particularly for the segmented liquid inlet 36 configurations similar to that shown in FIG. 3, where more than two chambers 30 are somewhat offset from the corresponding first and second segment 37, 39, that it may be advantageous for some posts 52b in the second liquid feed channels 40 to be sized or positioned differently from other posts 52b in the other second liquid feed channels 40, for example. A different cross-sectional shape for different posts is a further alternative (not shown). In other embodiments, the posts 52 may be symmetrically positioned about the nozzle orifice 32 and may have the same cross-sectional area as each other (FIGS. 2A and 2B).

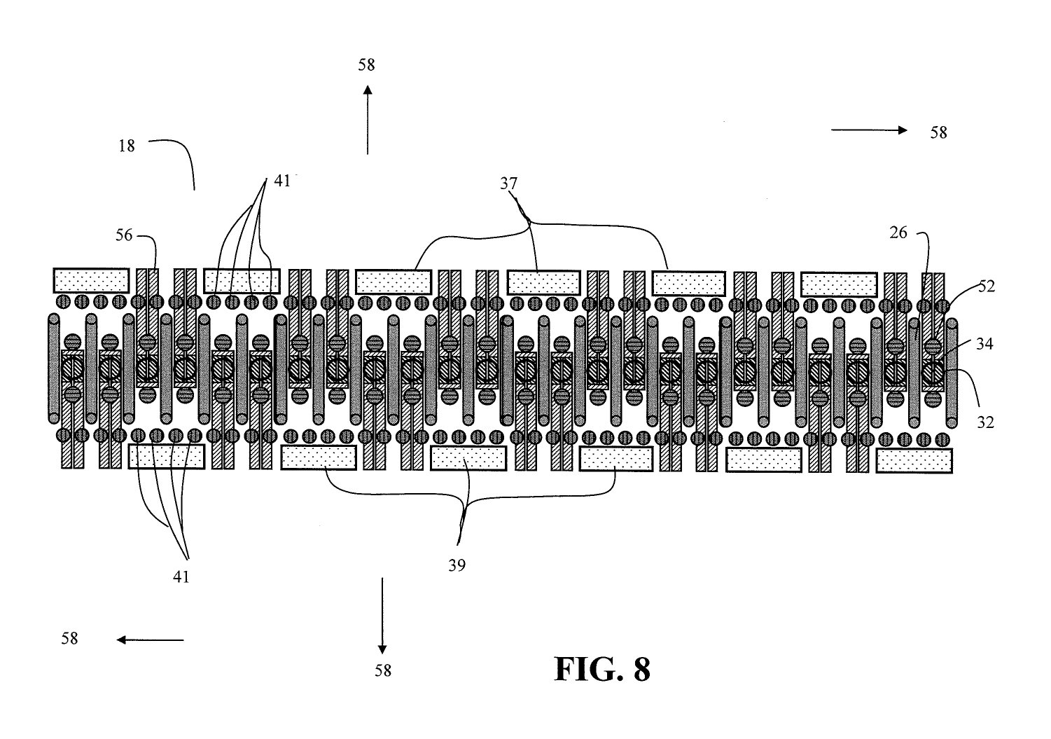

A lower magnification top view of a portion of the liquid ejection printhead die 18 is shown in FIG. 8. The twenty-four chambers shown in FIG. 8 are fed by the segmented liquid inlet 36 consisting of the six first segments 37 on one side of the chambers 30 and the six second segments 39, which are offset from the first segments 37, on the other side of the chambers 30. A typical liquid ejection printhead die 18 would typically have hundreds or even thousands of the chambers 30 and the corresponding first and second segments 37 and 39 of the segmented liquid feed inlet 36. FIG. 8 contains other elements similar to FIG. 2A, including the walls 26, the nozzle orifices 32, the resistive heating elements 34, the electrical leads 56, and the posts 52. In addition, FIG. 8 shows optional filter posts 41 located between the first and second segments 37, 39 of the liquid inlet 36 and the nozzle orifices 32, i.e. within the respective liquid feed channels 38 and 40. The filter posts 41 block particulates from clogging the chamber 30 at the post 52 or the nozzle 32. Even if a particle is caught between two adjacent filter posts 52, there are many parallel redundant fluid paths around the line of filter posts 52, so that all chambers 30 would continue to be supplied with ink. As shown in FIG. 8, the segmented liquid inlet 36 can be formed through the substrate 28 such that the first segments 37 and the second segments 39 are relatively close to the nozzle orifices 32. However, it is necessary to bring electrical leads 56 toward an edge 58 of the printhead die, such as edge 58a or 58b shown in FIG. 1. Typically one or more rows of bond pads (not shown) are provided along one or more edges 58, so that electrical interconnection can be made to the liquid ejection printhead die 18. As shown in FIG. 8, at least one electrical lead 56 extends from each resistive heating element 34 toward the edge 58 of the printhead die 18. Further, at least one of the electrical leads 56 is positioned between either neighboring segments of the first segments 37 or the second segments 39. In FIG. 8 some electrical leads 56 are positioned between the neighboring first segments 37, while the other electrical leads 56 are positioned between the neighboring second segments 39 of the liquid inlet 36.

Although there are various configurations of the dual feed liquid ejector 20, the essential features of the dual feed liquid ejector 20, as defined herein with application to thermal inkjet include a structure defining the chamber 30, the chamber 30 including a first surface and a second surface, the first surface including the nozzle orifice 32; the resistive heating element 34 located on the second surface of the chamber 30 opposite the nozzle orifice 32; the first liquid feed channel 38 and the second liquid feed channel 40 being in fluid communication with the chamber 30; and the segmented liquid inlet 36, the first segment 37 of the segmented liquid inlet 36 being in fluid communication with the first liquid feed channel 38, and the second segment 39 of the segmented liquid inlet 36 being in fluid communication with the second liquid feed channel 40. Such dual feed liquid ejectors 20 having a resistive heating element 34 that functions as the drop forming element are also sometimes called a dual feed thermal inkjet ejector herein. For an array of the dual feed liquid ejectors 20, as seen in the example described above relative to FIGS. 2A-2B, the first segment 37 of the segmented liquid inlet 36 is also in fluid communication with another one of the chambers 30 in the array, and the second segment 39 of the segmented liquid inlet 36 is also in fluid communication with another one of the chambers 30 in the array.

The initial primary motivation for the design of the dual feed liquid ejector 20 was to provide faster refill and higher drop ejection frequency to enable faster printing throughput as described above, and that predicted improved performance was verified by experiment. However, in testing the ejection of a range of different liquid compositions, including a variety of ink formulations, a surprising result was found. In particular, the dual feed thermal inkjet ejector 20 was found to provide much better latency than a conventional single feed thermal inkjet drop ejector when ejecting inks or other liquids that tend toward poor latency. In other words the dual feed thermal inkjet ejector 20 is able to consistently eject a drop of a latency challenged liquid after a waiting interval since the previously ejected drop that is at least several times longer, and up to more than an order of magnitude longer, than can be done with a conventional single feed thermal inkjet drop ejector. Some amount of improvement in latency with a dual feed thermal inkjet ejector could be expected due to having two sources of liquid feeding the chamber 30 rather than one source. Typically, as carrier fluid (such as water) evaporates near the nozzle, the less volatile components increase in viscosity, making it difficult to eject a drop. With two sources of liquid connected to the chamber 30 in a dual feed thermal inkjet ejector 20, more carrier fluid can diffuse toward the chamber 30. However, the large extent of the improvement in latency for a dual feed thermal inkjet ejector was unexpected.

Factors in Inks or Other Liquids that Influence Latency

U.S. Pat. No. 8,044,115, included by reference herein in its entirety, describes a number of factors that influence latency of a liquid, as summarized below.

Many inkjet inks are aqueous-based inks. By aqueous-based it is meant that the ink comprises mainly water as the carrier fluid for the remaining ink components. Pigment-based aqueous inks are defined as inks containing at least a dispersion of water-insoluble pigment particles. Dye-based inks are defined as inks containing at least a colored dye, which is soluble in the aqueous carrier. Colorless inks are defined as inks, which are substantially free of colorants such as dyes or pigments and as such, are not intended to contribute to color formation in the image forming process.

An ink set is defined as a set of two or more inks. The ink sets may contain inks of different colors, for example, cyan, magenta, yellow, red, green, blue, orange, violet or black. For example, a carbon black pigmented ink is used in an ink set comprising at least three inks having separately, a cyan, a magenta and a yellow colorant. Useful ink sets also include, in addition to the cyan, magenta and yellow inks, complementary colorants such as red, blue, violet, orange or green inks. In addition, the ink set can include light and dark colored inks, for example, light cyan and light magenta inks. It is possible to include one or more inks that comprise a mixture of different colorants in the ink set. An example of this is a carbon black pigment mixed with one or more colored pigments or a combination of different colored dyes in the same ink. An ink set can also include one or more colored inks in combination with one or more colorless inks. An ink set can also include at least one or more pigment-based inks in combination with additional inks that are dye-based ink.

Many pigment-based inks include pigment particles dispersed in the aqueous carrier using a polymeric dispersant. The pigment particles can be prepared by any method known in the art of inkjet printing. Useful methods commonly involve two steps: (a) a dispersing or milling step to break up the pigments to primary particles, where primary particle is defined as the smallest identifiable subdivision in a particulate system, and (b) a dilution step in which the pigment dispersion from step (a) is diluted with the remaining ink components to give a working strength ink.

Typically, polymeric dispersants are copolymers made from hydrophobic and hydrophilic monomers. In this case, the copolymers are designed to act as dispersants for the pigment by virtue of the arrangement and proportions of hydrophobic and hydrophilic monomers. The pigment particles are colloidally stabilized by the dispersant and are referred to as a polymer dispersed pigment dispersion. The pigment dispersions useful in pigment-based ink compositions desirably have a median particle diameter of less than 200 nm and more preferably less than 100 nm.

Typically, the weight average molecular weight of the copolymer dispersant has an upper limit such that it is less than about 50,000 Daltons. Desirably the weight average molecular weight of the copolymer preferably less than 10,000 Daltons. The molecular weight of the copolymer has a weight average molecular weight lower limit such that it is greater than about 500 Daltons.

Particularly useful polymeric pigment dispersants are further described in U.S. Publication 2006/0012654 and 2007/0043144, the disclosures of which are incorporated herein by reference.

Pigments suitable for use in an inkjet ink include, but are not limited to, azo pigments, monoazo pigments, disazo pigments, azo pigment lakes, β-Naphthol pigments, Naphthol AS pigments, benzimidazolone pigments, disazo condensation pigments, metal complex pigments, isoindolinone and isoindoline pigments, polycyclic pigments, phthalocyanine pigments, quinacridone pigments, perylene and perinone pigments, thioindigo pigments, anthrapyrimidone pigments, flavanthrone pigments, anthanthrone pigments, dioxazine pigments, triarylcarbonium pigments, quinophthalone pigments, diketopyrrolo pyrrole pigments, titanium oxide, iron oxide, and carbon black.

The pigment particles can be dispersed by a dispersant in an amount sufficient to provide stability in the aqueous suspension and subsequent ink. The amount of dispersant relative to pigment is a function of the desired particle size and related surface area of the fine particle dispersion. The ratio of pigment to dispersant can range from about 10:1 to about 1:1, and more preferably from about 5:1 to about 2:1. It is understood that the amount of polymer and relative ratios of the monomer constituents can be varied to achieve the desired particle stability and ink firing performance for a given pigment, as it is known that pigments can vary in composition and affinity for the dispersant.

Inkjet inks also optionally include self-dispersing pigments that are dispersible without the use of a dispersant. Pigments of this type are those that have been subjected to a surface treatment such as oxidation/reduction, acid/base treatment, or functionalization through coupling chemistry. The surface treatment can render the surface of the pigment with anionic, cationic or non-ionic groups. Examples of self-dispersing type pigments include, but are not limited to, Cab-β-Jet® 200 and Cab-O-Jet® 300 (Cabot Corp.) and Bonjet® Black CW-1, CW-2, and CW-3 (Orient Chemical Industries, Ltd.).

Ink compositions typically include one or more humectants to help retain water in the ink. Glycerol is an effective humectant for pigment-based inks and provides stable vapor bubble formation in a thermal inkjet printhead. Glycerol is a desirable ingredient in a thermal inkjet ink since it aids in maintaining the heater surface which leads to long term printhead lifetimes. Inks formulated with glycerol as a humectant typically tend toward good latency performance.

Inks are formulated not only to have good jetting performance, but also for desirable properties of the ejected drops on the recording medium 24 (FIG. 1). For example, some inks include at least one 1,2-alkanediol having from four to eight carbon atoms, such as 1,2-hexanediol. Such 1,2-alkanediols are known in the art of inkjet printing as penetrants or dynamic surface tension reducing agents and can be present at levels from about 1% to about 5% by weight. The presence of such diols can provide favorable interactions between the inks and the recording medium 24. However, they can also severely degrade the latency performance of inks formulated with polyhydric alcohol humectants commonly used in inkjet inks, such as glycerol. For example, the addition of a 1,2-alkanediol to a glycerol based ink can reduce the latency by an order of magnitude compared to inks containing no 1,2-alkanediol.

The latency performance of inks comprising glycerol and 1,2-alkanediols can be significantly improved by the additional presence of a pyrrolidinone compound. Preferred pyrrolidinone compounds include, 2-pyrrolidinone, 1-(2-hydroxyethyl)-2-pyrrolidinone, and 1-methyl-2-pyrrolidinone. The pyrrolidinone can be used alone or as a mixture of two or more such compounds. A particularly preferred combination of pyrrolidinones is a mixture of 2-pyrrolidinone and 1-(2-hydroxyethyl)-2-pyrrolidinone.

In order to help make the pigment particles adhere to the recording medium 24, ink compositions can also include at least one water-dispersible polymer binder, such as a polyurethane compound or an acrylic compound. By water-dispersible it is meant to include individual polymer molecules or colloidal assemblies of polymer molecules, which are stably dispersed in the ink without the need for a dispersing agent.

Preferred polymer binders have a sufficient amount of acid groups in the molecule to have an acid number from about 50 to about 150 in the case of a polyurethane binder, and around 300 for an acrylic binder. If the acid number of the binder polymer is too high, the resulting abrasion resistance of the image can become degraded, especially under conditions of high temperature and high humidity. If the acid number of the binder polymer is too low, a substantial amount of particulate polymer will exist and jetting can become degraded. The acid number is defined as the milligrams of potassium hydroxide required to neutralize one gram of polymer. The acid number of the polymer may be calculated as follows:

Acid number=(moles of acid monomer)*(56 grams/mole)*(1000)/(total grams of monomers), where moles of acid monomer is the total moles of all acid group containing monomers that comprise the polymer, 56 is the formula weight for potassium hydroxide and total grams of monomers is the summation of the weight of all the monomers, in grams, comprising the target polymer.

For excellent image durability on the recording medium 24, a polymeric binder, such as polyurethane, in an aqueous based pigmented ink preferably has a minimum molecular weight of at least 15,000. Polymeric binders such as polyurethane in an inkjet ink preferably have a maximum molecular weight of 150,000. Latency tends to decrease particularly for significant loading (1% or greater) of polymers having a molecular weight of greater than 15,000, especially where the ink also includes relatively high loading of pigment particles. Latency can be especially low for significant loading of polymers having a molecular weight of at least 20,000, and especially for higher acid numbers. The polyurethane dispersions useful as a binder preferably have a mean particle size of less than 100 nm and more preferably less than 50 nm.

Surfactants may be added to adjust the surface tension of the ink to an appropriate level, for example to control intercolor bleed between the inks. The surfactants can be anionic, cationic, amphoteric or nonionic and used at levels of 0.01 to 5% of the ink composition. A typical surfactant for an inkjet ink is Surfynol.

An anti-curl agent can be added to the ink to interact with the recording medium 24 such that the recording medium 24 does not curl up extensively after being printed upon. A particular type of anti-curl agent that has been demonstrated to be very effective in preventing curl, but also tends to cause the ink to have poor latency when using a conventional single feed thermal inkjet drop ejector is a branched, polyethylene glycol ether of at least 0.5 percent by weight. Such branched polyethylene glycol ether materials include those based on glycerol, such as the Liponic or Glycereth materials, and also those based on pentaerythritol, such as the pentaerythritol ethoxylates and propoxylates.

A biocide (0.01-1.0% by weight) can also be added to prevent unwanted microbial growth which may occur in the ink over time. Additional additives which can optionally be present in an inkjet ink composition include thickeners, conductivity enhancing agents, anti-kogation agents, drying agents, waterfast agents, dye solubilizers, chelating agents, binders, light stabilizers, viscosifiers, buffering agents, anti-mold agents, stabilizers and defoamers.

The dual feed liquid ejectors 20 can also be used to eject liquids other than inkjet inks that are used in the printing of images. For example, in the field of functional printing, devices, circuitry or structures can be fabricated on a substrate (analogous to recording medium 24) by ejecting one or more liquids in patternwise fashion. Liquids for making such devices, circuitry or structures can include electrically conductive particulate or polymeric material for making a conductive portion, resistive material for making a resistive portion, insulating material for making an insulating portion, semiconducting material for making a semiconducting portion, magnetic material for making a magnetic portion or structural materials such as polymers for making a structural member. In order to make a conductive member with suitably high conductivity, it can be advantageous to use a particle loading of metal particles, such as silver particles, of at least 4 percent by weight. In order to bind the conductive particles to the substrate it can be advantageous to have a polymer loading of at least 1 percent by weight.

Although many of the ink compositions and other liquids described herein can be ejected through a conventional single feed thermal inkjet drop ejector, such as the liquid ejector described in U.S. Pat. No. 7,600,856, it has been found that when certain components or combinations of components are included at high enough loading levels, the latency of the ink or other liquid can be adversely affected. As a result it becomes necessary to eject maintenance drops as often as every few seconds so that the liquid ejector is consistently able to eject drops as needed for printing an image or forming a device or other structure. Short latency times adversely impact ejection productivity and also waste ink or other ejection liquids.

### Latency Score Metric

Latency of an ejection liquid in a liquid ejector can be characterized relative to a maximum time interval between reliably ejecting a drop and a previous drop. The longer the time interval, the better the latency is. Desirable latency times depend upon the application. For example, a desktop carriage inkjet printer can print a swath of an image in less than a second, but it can require five seconds or more to print a letter-sized color image, and thirty seconds or more to print a high quality photographic image in a multi-pass print mode. For a wide format printer, the swath time can be greater than two seconds, and the total print time can be several minutes. The printhead needs to eject maintenance drops (typically into a cap or spittoon outside of the printing region) frequently enough that the poorest latency ink in the ink set continues to be reliably ejectable over the range of temperatures and humidities that can be encountered in the printer. Latency times that are less than a few seconds can significantly slow down printing throughput.

An additional consideration is how many maintenance drops are required after the time interval in order to ensure continued reliable ejection. It has been observed that if the ink or other liquid in a liquid ejector has increased in viscosity in the nozzle region, multiple firing attempts can be required to restore desirable jetting performance. For this reason, rather than firing only a single maintenance drop from each liquid ejector, it is more typical to pulse each liquid ejector multiple times, for example 5 to 20 times, while the printhead is at the cap or spittoon. The first firing, or the first several firings, may not even result in ejection of a drop at all. When drops begin to be ejected, they can have slow velocity or otherwise poor performance. As the time interval between ejecting a drop and the previous drop increases, more and more maintenance drops can be required to restore jetting performance. For sufficiently long time intervals, as many as 50 maintenance drop firings can be required. It is sometimes considered not to be practical to use time intervals that require attempting to eject more than about 50 maintenance drops.

A new testing method and metric have been devised to characterize latency performance of different liquids in different liquid ejectors based on how many failed ejections occur at various wait time intervals. A printhead or other liquid ejector is mounted in a jetting fixture having a drop detection device, such as an optical sensor. The ink or other liquid of interest is connected to the inlet of the liquid ejector and primed to fill the chambers near the nozzles. The liquid ejector is then pulsed multiple times while monitoring the ejected drops until stable jetting performance is observed. Then a sequence of pulsing groups of firing pulses with each group separated by successively increasing wait times is run while monitoring the ejected drops. For example, each group of firing pulses can include 50 pulses for the liquid ejector. Successive wait times can include 1 second, 2 seconds, 5 seconds, 10 seconds, 20 seconds, 30 seconds, 50 seconds, 75 seconds, 100 seconds, 200 seconds and 500 seconds. A new latency metric called the latency score LS is defined below in equation (1):

$$LS = \frac{{\sum }_{( a = 1 to 50 )} {\sum }_{( {t}_{w} = 1 to 500 )} {Et}_{w} / a }{{LS}_{max}} \qquad ( 1 )$$

where E=ejection observed (1 or 0);
a=number of jetting attempts (1 to 50);
t_{w}=wait time in seconds (1, 2, 5, 10, 20, 30, 40, 50, 75, 100, 200, and 500); and
LSₘₐₓ, is the maximum value of the double summation if each E equals 1.

A perfect latency score is LS=1.0, and the higher the latency score the better. For the wait times t_{w} listed above, LSₘₐₓ˜4647.7, which is used to normalize the latency score. The rationale for the latency score calculation is that an ink or other liquid has better latency if drops can be successfully ejected (E=1) even for long wait times t_{w}. Relatively few unsuccessful jetting attempts (E=−0) at a given wait time is also preferred.

The latency score provides a compact comparison of different inks or other liquids being ejected from different types of ejectors without getting into the details of exactly which drops failed to fire. To understand what various ranges of latency scores imply, Table 1 lists the calculated latency score for various numbers of failed drops at different wait times. The examples in Table 1 are selected based on observing that the typical behavior is that for comparatively short wait times all drops are ejected successfully. For successively longer wait times, more and more of the initial attempted firings fail as wait time is increased. Note in the first several entries in the table, due to the heavy weighting on weight time t_{w}, especially for the initial attempt (a=1), the latency score drops fairly rapidly from the perfect score of 1 due to relatively few initial drop failures at long wait times of 500 seconds or 200 seconds.

Qualitative ratings are indicated in the leftmost column of Table 1. It is important to note that the qualitative ratings depend on context. For example, because of the longer wait time required when printing with a wide format printer as compared to a desktop carriage printer, fair latency for a desktop printer might be poor latency for a wide format printer. In addition, the latency score is based upon whether a drop was successfully ejected or not. It does not take into account the quality of the ejected drop. For example, after several failed attempts at a given wait time a particular drop might be ejected, but the first successfully ejected drop or drops at a given wait time might have poor velocity and directionality, and thereby not satisfactory for high quality printing. The latency score is a compact comparative indicator of the performance of various inks and other liquids in different ejectors using a simple measurement technique. However, it does not take the place of printing experiments within an actual printer over its entire range of operating temperatures and humidities to determine an actual maintenance algorithm.

The rationale for some of the qualitative ratings is as follows. If there are no failed ejections for wait times of over 1 minute, and if even at wait times of 100 seconds, 200 seconds and 500 seconds the ejector successfully ejects drops after a number of attempts that is consistent with typical maintenance routines (spitting 5-20 drops), then the latency of that ink or other liquid with that ejector is outstanding. Thus, according to Table 1, a latency score of 0.44 or greater is consistent with outstanding latency performance. On the other hand, if the first few drops fail to eject at a wait time of 5 seconds, and successively more drops fail to eject at longer wait times, the latency is poor. If the first few drops fail to eject at a wait time of 1 second, and successively more drops fail to eject at longer wait times, the latency of that ink or other liquid and ejector type is probably unusable. From the table below, poor latency is characterized by a latency score between 0.003 and 0.014. The ratings are intended to provide guidelines for comparison, not to specify maintenance routines.

TABLE 1
Latency Scores for Various Examples of Initial Drop Failures

| | Failed Initial Drops | | | | | | | | | | | | |
|---|---|---|---|---|---|---|---|---|---|---|---|---|---|
| | 1 | 2 | 5 | 10 | 20 | 30 | 40 | 50 | 75 | 100 | 200 | 500 | LS |
| Outstanding | 0 | 0 | 0 | 0 | 0 | 0 | 0 | 0 | 0 | 0 | 0 | 0 | 1 |
| Outstanding | 0 | 0 | 0 | 0 | 0 | 0 | 0 | 0 | 0 | 0 | 0 | 1 | 0.892 |
| Outstanding | 0 | 0 | 0 | 0 | 0 | 0 | 0 | 0 | 0 | 0 | 1 | 1 | 0.849 |
| Outstanding | 0 | 0 | 0 | 0 | 0 | 0 | 0 | 0 | 0 | 0 | 0 | 2 | 0.839 |
| Outstanding | 0 | 0 | 0 | 0 | 0 | 0 | 0 | 0 | 0 | 5 | 10 | 20 | 0.438 |
| Excellent | 0 | 0 | 0 | 0 | 0 | 0 | 0 | 0 | 5 | 10 | 20 | 40 | 0.285 |
| Very Good | 0 | 0 | 0 | 0 | 0 | 0 | 5 | 10 | 20 | 40 | 50 | 50 | 0.121 |
| Good | 0 | 0 | 0 | 0 | 5 | 10 | 20 | 40 | 50 | 50 | 50 | 50 | 0.047 |
| Fair | 0 | 0 | 5 | 10 | 20 | 40 | 50 | 50 | 50 | 50 | 50 | 50 | 0.014 |
| Poor | 5 | 10 | 20 | 40 | 50 | 50 | 50 | 50 | 50 | 50 | 50 | 50 | 0.003 |

### Latency Score Comparisons for Dual Feed and Conventional Ejectors

Table 2 summarizes experimental data and the corresponding latency scores for a variety of pigmented inks having a range of total solids content (percent by weight of pigment plus percent by weight of polymer) when ejected from a conventional single feed thermal inkjet ejector (for example, the drop ejector described in U.S. Pat. No. 7,600,856) versus a dual feed thermal inkjet ejector as described above with reference to FIGS. 1-8. The drop ejectors of both types were sized to eject drops having a nominal drop volume of 3 picoliters. The solids content in percent is the sum of the pigment (pigm) percent by weight, the polymer dispersant (disp) by weight and the polymer binder (bind) by weight. In the ink names in the leftmost column, M indicates magenta pigment and C indicates cyan pigment. The measurements were made at ambient temperatures T of both 21 C. and 35 C. Inkjet printers are typically specified to operate even beyond these temperature ranges. Viscosity for each of the inks at 20 C. is provided and ranges from 2.18 cps to 4.15 cps. An average over plural measurements of latency scores is provided.

TABLE 2
Latency Scores as a Function of Solids Content of Inks

| | % | | % | | Visc | | | | |
|---|---|---|---|---|---|---|---|---|---|
| Ink | pigm | % disp | bind | % solids | cps | Ejector | T | LS | Rating |
| M1 | 2.50 | 0.63 | 2.00 | 5.13 | 2.42 | Single feed | 21 | 0.10 | Good |
| M1 | 2.50 | 0.63 | 2.00 | 5.13 | | Dual feed | 21 | 1.00 | Outstanding |
| M1 | 2.50 | 0.63 | 2.00 | 5.13 | | Single feed | 35 | 0.15 | Very Good |
| M1 | 2.50 | 0.63 | 2.00 | 5.13 | | Dual feed | 35 | 0.82 | Outstanding |
| M2 | 5.00 | 1.25 | 2.00 | 8.25 | 3.22 | Single feed | 21 | 0.057 | Good |
| M2 | 5.00 | 1.25 | 2.00 | 8.25 | | Dual feed | 21 | 0.89 | Outstanding |
| M2 | 5.00 | 1.25 | 2.00 | 8.25 | | Single feed | 35 | 0.029 | Fair |
| M2 | 5.00 | 1.25 | 2.00 | 8.25 | | Dual feed | 35 | 0.75 | Outstanding |
| M3 | 5.00 | 1.25 | 3.00 | 9.25 | 3.62 | Single feed | 21 | 0.048 | Good |
| M3 | 5.00 | 1.25 | 3.00 | 9.25 | | Dual feed | 21 | 0.80 | Outstanding |
| M3 | 5.00 | 1.25 | 3.00 | 9.25 | | Single feed | 35 | 0.011 | Poor |
| M3 | 5.00 | 1.25 | 3.00 | 9.25 | | Dual feed | 35 | 0.61 | Outstanding |
| M4 | 6.00 | 1.50 | 3.00 | 10.50 | 4.15 | Single feed | 21 | 0.032 | Fair |
| M4 | 6.00 | 1.50 | 3.00 | 10.50 | | Dual feed | 21 | 0.57 | Outstanding |
| M4 | 6.00 | 1.50 | 3.00 | 10.50 | | Single feed | 35 | 0.005 | Poor |
| M4 | 6.00 | 1.50 | 3.00 | 10.50 | | Dual feed | 35 | 0.47 | Outstanding |
| C1 | 2.50 | 0.50 | 1.20 | 4.20 | 2.18 | Single feed | 21 | 0.53 | Outstanding |
| C1 | 2.50 | 0.50 | 1.20 | 4.20 | | Dual feed | 21 | 0.89 | Outstanding |
| C1 | 2.50 | 0.50 | 1.20 | 4.20 | | Single feed | 35 | 0.37 | Excellent |
| C1 | 2.50 | 0.50 | 1.20 | 4.20 | | Dual feed | 35 | 0.85 | Outstanding |
| C2 | 5.00 | 1.00 | 1.20 | 7.20 | 2.82 | Single feed | 21 | 0.25 | Excellent |
| C2 | 5.00 | 1.00 | 1.20 | 7.20 | | Dual feed | 21 | 0.77 | Outstanding |
| C2 | 5.00 | 1.00 | 1.20 | 7.20 | | Single feed | 35 | 0.055 | Good |
| C2 | 5.00 | 1.00 | 1.20 | 7.20 | | Dual feed | 35 | 0.75 | Outstanding |

From the results listed in Table 2, although latency ratings with the single feed thermal inkjet ejector range from poor to outstanding for the different inks and temperatures, the latency ratings using the dual feed thermal inkjet ejector are consistently outstanding. Comparing the latency scores LS with the examples in Table 1, it is evident that the wait times that a dual feed thermal inkjet ejector can experience and still eject drops of the inks listed in Table 2 can be over an order of magnitude longer than the wait times that a single feed thermal inkjet ejector can experience and still eject drops.

It is also evident from Table 2 that latency scores typically decrease as the total solids content increases. Still, for the entire range studied here, whether the solids content was greater than 5%, 6%, 7%, 8%, 9% or 10%, the latency rating for ejecting the various inks through the dual feed thermal inkjet ejector was consistently outstanding and significantly improved relative to the single feed thermal inkjet drop ejector.

Pigment particle loading is especially important for some inks. In particular, in order to achieve a sufficiently wide color gamut using presently available pigments on a wide range of recording media, it is required to have a magenta pigment loading of at least 4% by weight in the magenta ink. As can be seen from Table 2, a dual feed thermal inkjet ejector has no latency issues for ejecting inks with a magenta pigment particle loading of at least 4% or even higher by weight, while latency for a conventional single feed thermal inkjet liquid ejector is typically marginal, especially at the higher end of temperatures encountered in a printer.

With regard to the portion of solids content that is due to polymers, it is found to be advantageous for an aqueous based pigmented ink if the dispersant polymer loading is at least 10% of the pigment loading by weight (i.e. at least 0.4% by weight in a magenta ink having a magenta pigment loading of 4% by weight). For durability of the printed image on the recording medium it is also advantageous for the binder polymer loading to be at least 1% by weight in the ink. Thus, for a magenta ink having a magenta pigment loading of 4% by weight, the solids content is preferably at least 5.4% by weight.

Each of the aqueous based pigmented inks represented in Table 2 includes the same amounts of glycerol, 1,2-hexanediol, 2-pyrrolidinone, and Surfynol. For each of the inks in Table 2, the binder polymer is a water-dispersible polyurethane having a molecular weight of 17,600. Molecular weight of the polymeric dispersant had a weight average of less than 15,000. The magenta pigment was the same for all of the magenta inks and the cyan pigment was the same for all of the cyan inks. Thus, although the solids loading is varied in the experiments listed in Table 2, the other ink components were held constant.

A set of experiments was also run to determine latency scores for dual feed thermal inkjet ejectors versus single feed thermal inkjet ejectors (each sized for a nominal drop volume of 3 picoliters) using a set of aqueous based pigment inks, including high solids content with significant loading of polymers having molecular weights of 20,000 and above, as well as a range of acid numbers. The results are listed below in Table 3. Each of the inks in the test included constant amounts of glycerol, 1-2 hexanediol, 1-(2-hydroxyethyl)-2-pyrrolidinone, and Surfynol. Each of the test inks also included magenta pigment at a loading of 5% by weight. The polymer loading was 2 percent by weight of a series of different molecular weight (MW) water-dispersible polyurethanes.

TABLE 3
Latency Scores as a Function of Molecular Weight and Acid #

| Urethane | MW | Acid # | Visc | Ejector | LS | Rating |
|---|---|---|---|---|---|---|
| 1 | 20,000 | 100 | 3.01 | Single feed | 0.033 | Fair |
| 1 | 20,000 | 100 | 3.01 | Dual feed | 0.84 | Outstanding |
| 2 | 53,300 | 100 | 4.16 | Single feed | 0.030 | Fair |
| 2 | 53,300 | 100 | 4.16 | Dual feed | 0.30 | Excellent |
| 3 | 29,900 | 85 | 2.76 | Single feed | 0.13 | Very Good |
| 3 | 29,900 | 85 | 2.76 | Dual feed | 0.76 | Outstanding |
| 4 | 40,500 | 85 | 3.00 | Single feed | 0.076 | Good |
| 4 | 40,500 | 85 | 3.00 | Dual feed | 0.57 | Outstanding |
| 5 | 89,600 | 85 | 4.17 | Single feed | 0.036 | Fair |
| 5 | 89,600 | 85 | 4.17 | Dual feed | 0.12 | Very Good |
| 6 | 39,800 | 85 | 3.29 | Single feed | 0.11 | Good |
| 6 | 39,800 | 85 | 3.29 | Dual feed | 0.61 | Outstanding |
| 7 | 56,500 | 120 | 4.55 | Single feed | 0.042 | Fair |
| 7 | 56,500 | 120 | 4.55 | Dual feed | 0.26 | Very Good |
| 8 | 88,000 | 120 | 6.99 | Single feed | 0.015 | Fair |
| 8 | 88,000 | 120 | 6.99 | Dual feed | 0.016 | Fair |

From the results listed in Table 3, it is evident that latency scores tend to decrease as molecular weight of the polyurethane binder polymer increases, and also as acid number increases. Comparing the latency ratings between a conventional single feed thermal inkjet ejector and a dual feed thermal inkjet ejector, the dual feed thermal inkjet ejector almost always has significantly better latency. However, comparing the last pair of entries in the table when both the molecular weight (88,000) and the acid number (120) are high, the latency is significantly affected even for a dual feed thermal inkjet ejector, so that there is only marginal improvement relative to a conventional single feed thermal inkjet ejector, particularly when the ejector is sized to eject drops as small as 3 picoliters.

It was noted above that a particular type of anti-curl agent that has been demonstrated to be very effective in preventing curl in printed documents, but also tends to cause the ink to have poor latency when using a conventional single feed thermal inkjet drop ejector is a branched polyethylene glycol ether of at least 0.5 percent by weight. A set of experiments was run to determine latency scores for dual feed thermal inkjet ejectors versus single feed thermal inkjet ejectors (each sized for a nominal drop volume of 3 picoliters) using a set of aqueous based pigment inks including high solids content plus various amounts of Liponic EG-1. Liponic EG-1 is also called glycerth-26 and is an example of a branched polyethylene glycol ether. The results are listed below in Table 4. Each of the inks in the test included constant amounts of glycerol, 1-2 hexanediol, 1-(2-hydroxyethyl)-2-pyrrolidinone, and Surfynol. Each of the test inks also included magenta pigment at a loading of 5% by weight. The polymer loading included 2 percent by weight of a water-dispersible polyurethane having a molecular weight of 20,300.

TABLE 4
Latency Scores as a Function of Amount of Liponic EG-1

| Test Ink | Lipomc EG-1% | Visc | Ejector | LS | Rating |
|---|---|---|---|---|---|
| 1 | 0 | 3.01 | Single feed | 0.21 | Very Good |
| 1 | 0 | 3.01 | Dual feed | 1.00 | Outstanding |
| 2 | 0.5 | 3.05 | Single feed | 0.11 | Good |
| 2 | 0.5 | 3.05 | Dual feed | 1.00 | Outstanding |
| 3 | 1.0 | 3.12 | Single feed | 0.061 | Good |
| 3 | 1.0 | 3.12 | Dual feed | 1.00 | Outstanding |
| 4 | 2.0 | 3.24 | Single feed | 0.045 | Fair |
| 4 | 2.0 | 3.24 | Dual feed | 0.89 | Outstanding |
| 5 | 4.0 | 3.48 | Single feed | 0.027 | Fair |
| 5 | 4.0 | 3.48 | Dual feed | 0.71 | Outstanding |

From the results listed in Table 4, it is evident that latency scores decrease for the conventional single feed thermal inkjet ejector with increasing amounts of Liponic EG-1, but the latency score ratings are consistently outstanding when using a dual feed thermal inkjet ejector. Thus while the effect on latency performance of an ink containing such an anti-curl agent can cause the designers of an inkjet printing system to omit this ink component when using a printhead having conventional single feed thermal inkjet ejectors, the anti-curl agent can be included even in high solids content inks if a printhead having dual feed thermal inkjet ejectors is used. Thus, not only are prints provided more quickly, they also have a more pleasing appearance and flat shape.

Viscosities of the test inks in Tables 2 through 4 range between 2 and 7 centipoise. Inks having viscosities ranging from 2 to 10 centipoise can be jetted using dual feed thermal inkjet ejectors, although at viscosities above 5 cps a drop ejector sized for nominal drop volumes of greater than 3 picoliters can be more appropriate, especially for high solids content liquids. The viscosity ranges referred to herein refer to the viscosity of the ink or other liquid that is supplied to the liquid ejector. As water or other carrier fluid evaporates near the nozzle during extended wait times before firing, the local viscosity near the nozzle increases further, but that increased local viscosity is not what is referred to in the viscosity measurements or viscosity ranges herein.

It was noted above that dual feed thermal inkjet ejectors can also be used to eject liquids other than inkjet inks that are used in the printing of images. For example, in the field of functional printing, devices, circuitry or structures can be fabricated on a substrate (analogous to recording medium 24) by ejecting one or more liquids in patternwise fashion. Conductive polymers are one class of polymers that are becoming increasingly important and new ways of applying such polymers are correspondingly important. A particular conductive material of great interest is PEDOT, which stands for the polymerization of 3,4-ethylenedioxythiophene to Poly(EthyleneDiOxyThiophene). PEDOT is difficult to solubilize, so it is formed as a dispersion using poly(styrene sulfonate) or PSS as a carrier polymer. The PSS is typically very high molecular weight. In the case of the Heraeus Clevios™ materials PH1000 and FEK, the molecular weight of the PSS is at least 200,000. Furthermore it has an ionizable group on each monomer unit making it very water soluble, but also causing the viscosity to build rapidly at low solids content. Some information is copied below from the Heraeus website on their highly conductive Clevios™ materials:

“Generally speaking, polymers are insulators. However, there is a special class of polymers—the intrinsically conductive polymers—that have conductivity levels between those of semiconductors and metals (from 10⁻⁴ to 10³ S/cm). The combination of metal and polymer properties opens up new opportunities in many applications, particularly in the electronics industry. With PEDOT (poly(3,4-ethylenedioxythiophene))—available under the trade name Clevios™—Heraeus has developed the latest generation of conductive polymers which are characterized by outstanding properties: high conductivity, high transparency, high stability, and easy processing. For high conductive coatings Clevios™ PH 1000 or its ready to use formulation, Clevios™ FE-T can be used. These materials offer not only high conductivities but also exceptional levels of transparency. A conductivity of 900-1000 S/cm (approx. 200 Ohm/sq) can be reached by using Clevios™ PH 1000 together with a conductivity enhancement agent such as DMSO or ethylene glycol. The ready to use formulation CLEVIOS™ FE-T is water-based and contains a polyester dispersion for force dry applications. Coating formulations have been optimized for individual substrates, such as A-PET, PET, polycarbonate, glass for different wet film thicknesses and surface resistivities. Coating can be achieved by standard printing processes, such as slit die, flexographic, screen or gravure methods. Also brushing, spraying, spin-coating or roller coating can be used.”

Clevios™ PH 1000 is a dispersion of the PEDOT with the PSS in a ratio of 1:2.5. In other words, in PH 1000 the high molecular weight PSS component is about 71% of the polymer loading. Clevios™ PH 1000 is supplied as a 1.3 wt % solids in water and is diluted as specified to make ink formulations typically below 1% solids. The high molecular weight and high degree of ionization of the PSS causes the viscosities to be high at relatively low solids content. FEK is a custom material similar to the FE-T material referred to on the Heraeus website. The specifications are proprietary.

A set of experiments was run to determine latency scores for dual feed thermal inkjet ejectors versus single feed thermal inkjet ejectors (each sized for a nominal drop volume of 3 picoliters) using a set of aqueous based test fluids including Clevios™ PH 1000 or Clevios™ FEK. Each of the test fluids included ethylene glycol and also included either Surfynol or Capstone FS-35 as a surfactant. The results are listed in Table 5 below.

TABLE 5
Latency Scores for Clevios ™ Polymer Test Liquids

| Test | Clevios ™ | | | | | |
|---|---|---|---|---|---|---|
| Liquid | Material | Surfactant | Visc | Ejector | LS | Rating |
| 1 | 0.50% | 0.10% | 6.98 | Single | 1.00 | Outstanding |
| | PH 1000 | Capstone | | feed | | |
| 1 | 0.50% | 0.10% | 6.98 | Dual feed | 1.00 | Outstanding |
| | PH 1000 | Capstone | | | | |
| 2 | 0.50% | 0.10% | 10.89 | Single | Fail | Failed |
| | FEK | Capstone | | feed | | |
| 2 | 0.50% | 0.10% | 10.89 | Dual feed | 0.14 | Very Good |
| | FEK | Capstone | | | | |
| 3 | 0.50% | 0.50% | 7.07 | Single | 1.00 | Outstanding |
| | PH 1000 | Surfynol | | feed | | |
| 3 | 0.50% | 0.50% | 7.07 | Dual feed | 1.00 | Outstanding |
| | PH 1000 | Surfynol | | | | |
| 4 | 0.50% | 0.50% | 11.00 | Single | Fail | Failed |
| | FEK | Surfynol | | feed | | |
| 4 | 0.50% | 0.50% | 11.00 | Dual feed | 0.93 | Outstanding |
| | FEK | Surfynol | | | | |
| 5 | 0.75% | 0.10% | 15.09 | Single | 0.42 | Excellent |
| | PH 1000 | Capstone | | feed | | |
| 5 | 0.75% | 0.10% | 15.09 | Dual feed | 0.89 | Outstanding |
| | PH 1000 | Capstone | | | | |

From the results listed in Table 5, it is evident that jetting performance and latency scores vary widely for the conventional single feed thermal inkjet ejector depending primarily upon whether PH 1000 or FEK is the Clevios™ material being ejected. In fact, whether Capstone FS-35 or Surfynol was used as a surfactant, FEK was not jettable using the conventional single feed ejector, while for the dual feed thermal inkjet latency scores were very good or outstanding respectively. At a content of 0.5% PH 1000, latency scores were outstanding for both the single feed and the dual feed thermal inkjet ejectors. However, as the content of PH 1000 is increased to 0.75%, the latency score drops somewhat for the single feed thermal inkjet ejector. Thus, for better jetting performance and latency, the dual feed thermal inkjet ejector has a wider latitude for ejecting these conductive polymer materials and at higher concentrations. Although it can seem surprising that even the single feed ejector has excellent to outstanding latency scores for the PH 1000 test liquids, this illustrates that it is not necessarily the viscosity of the liquid provided to the ejector by the liquid supply that determines the latency, but rather how much the viscosity increases near the nozzle when water is lost by evaporation.

Inkjet Printing System with Dual Feed Thermal Inkjet Ejectors

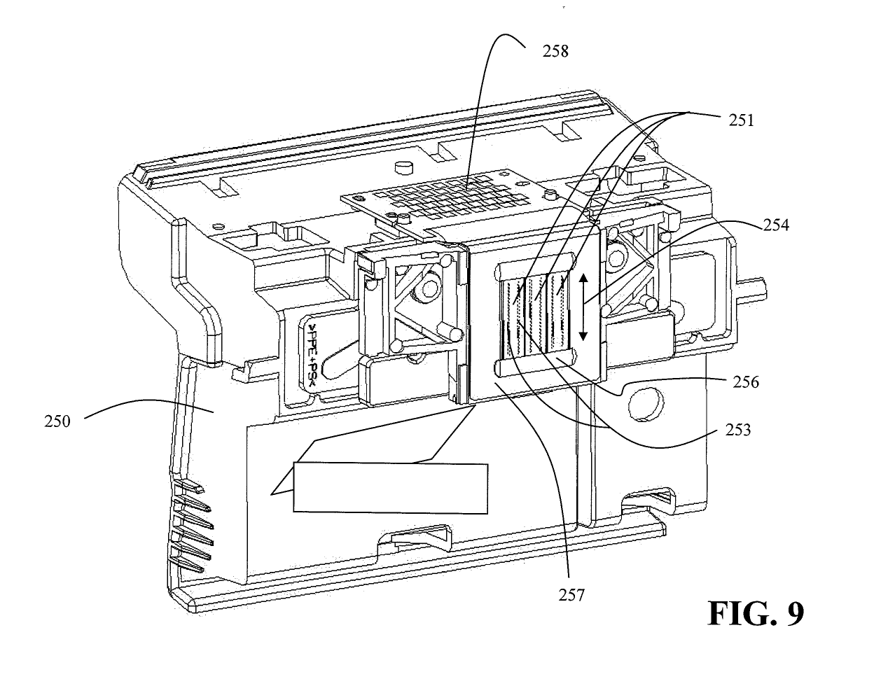

FIG. 9 shows a perspective of a portion of a printhead 250. The printhead 250 includes three printhead die 251 (similar to liquid ejection printhead die 18 in FIG. 1), each printhead die 251 containing two nozzle arrays 253, so that the printhead 250 contains six nozzle arrays 253 altogether. The six nozzle arrays 253 in this example can each be connected to separate ink sources (not shown in FIG. 2); such as cyan, magenta, yellow, text black, photo black, and a colorless protective printing fluid. Each nozzle in the nozzle arrays 253 corresponds to a dual feed thermal inkjet ejector as described above relative to FIGS. 1-8. Each of the six nozzle arrays 253 is disposed along a nozzle array direction 254, and the length of each nozzle array 253 along the nozzle array direction 254 is typically on the order of 1 inch or less. Typical lengths of recording media are 6 inches for photographic prints (4 inches by 6 inches) or 11 inches for paper (8.5 by 11 inches), or even larger for a wide format printer. Thus, in order to print a full image, a number of swaths are successively printed while moving the printhead 250 across the recording medium 24. Following the printing of a swath, the recording medium 24 is advanced along a media advance direction that is substantially parallel to the nozzle array direction 254.

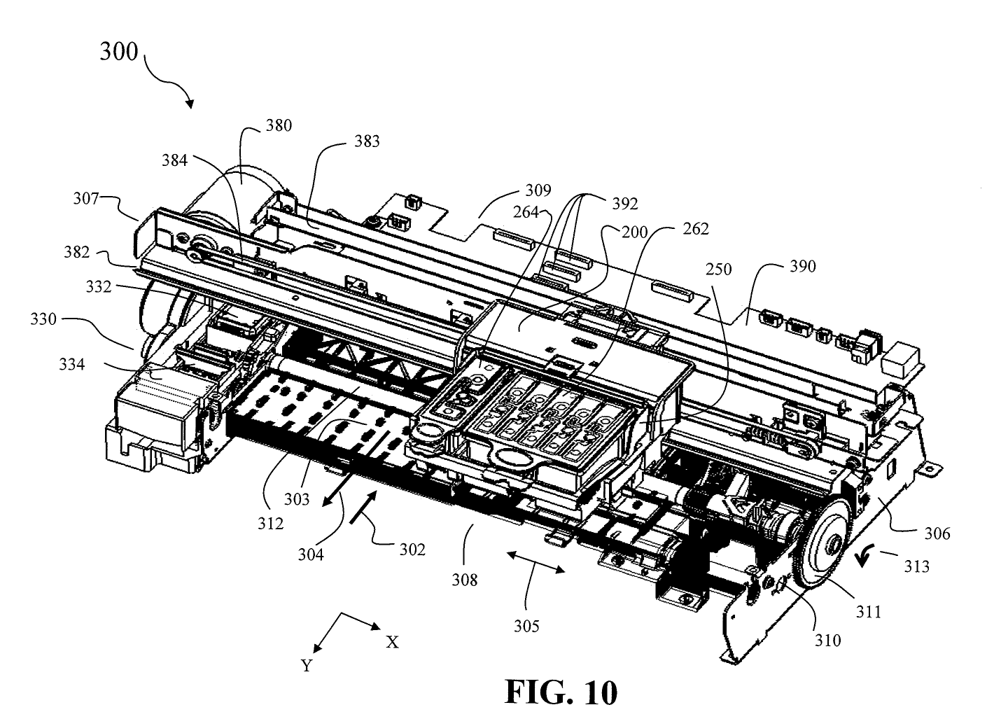

Also shown in FIG. 9 is a flex circuit 257 to which the printhead die 251 are electrically interconnected, for example, by wire bonding or TAB bonding. The interconnections are covered by an encapsulant 256 to protect them. The flex circuit 257 bends around the side of the printhead 250 and connects to a connector board 258. When the printhead 250 is mounted into a carriage 200 (see FIG. 10), the connector board 258 is electrically connected to a connector (not shown) on the carriage 200, so that electrical signals can be transmitted to the printhead die 251.

FIG. 10 shows a portion of a desktop carriage printer. Some of the parts of the printer have been hidden in the view shown in FIG. 10 so that other parts can be more clearly seen. A printing mechanism 300 has a print region 303 across which the carriage 200 is moved back and forth in a carriage scan direction 305 along the X axis, between a right side 306 and a left side 307 of the printing mechanism 300, while drops are ejected from the printhead die 251 (not shown in FIG. 10) on the printhead 250 that is mounted on the carriage 200. A carriage motor 380 moves a belt 384 to move the carriage 200 along a carriage guide rail 382. An encoder sensor (not shown) is mounted on the carriage 200 and indicates carriage location relative to an encoder fence 383.

The printhead 250 is mounted in the carriage 200, and a multi-chamber ink supply 262 and a single-chamber ink supply 264 are mounted in the printhead 250. The mounting orientation of the printhead 250 is rotated relative to the view in FIG. 9, so that the printhead die 251 are located at the bottom side of the printhead 250, the droplets of ink being ejected downward onto the recording medium 24 in the print region 303 in the view of FIG. 10. The multi-chamber ink supply 262, in this example, contains five ink sources: cyan, magenta, yellow, photo black, and colorless protective fluid; while the single-chamber ink supply 264 contains the ink source for text black. Paper or other recording medium 24 (sometimes generically referred to as paper or media herein) is loaded along a paper load entry direction 302 toward the front of a printing mechanism 308.

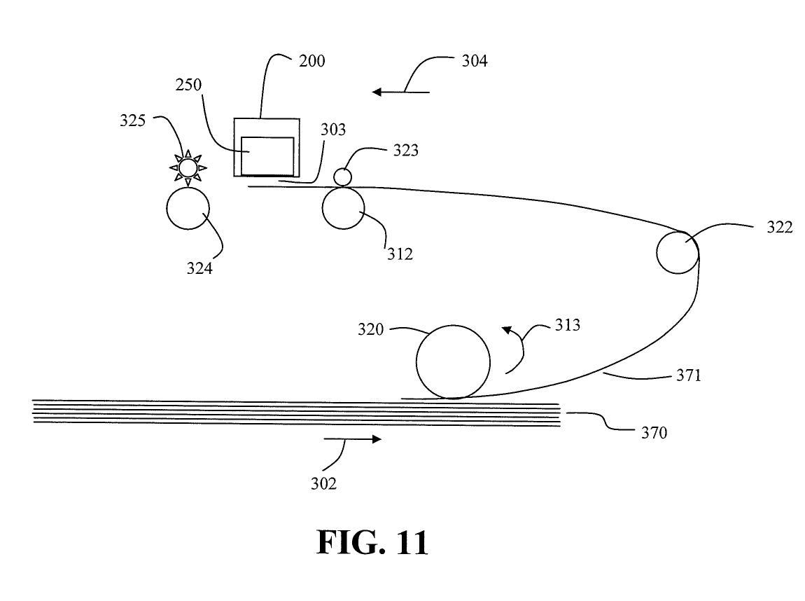

A variety of rollers are used to advance the recording medium 24 through the printer as shown schematically in the side view of FIG. 11. In this example, a pick-up roller 320 moves a top piece or sheet 371 of a stack 370 of paper or other recording medium 24 in the direction of arrow, the paper load entry direction 302. A turn roller 322 acts to move the paper around a C-shaped path (in cooperation with a curved rear wall surface) so that the paper continues to advance along a media advance direction 304 from a rear 309 of the printing mechanism (with reference also to FIG. 10). The paper is then moved by a feed roller 312 and idler roller(s) 323 to advance along the Y axis across the print region 303 near the printhead 250 for printing, and from there to a discharge roller 324 and star wheel(s) 325 so that printed paper exits along the media advance direction 304. The feed roller 312 includes a feed roller shaft along its axis, and a feed roller gear 311 is mounted on the feed roller shaft. The feed roller 312 can include a separate roller mounted on the feed roller shaft, or can include a thin high friction coating on the feed roller shaft. A rotary encoder (not shown) can be coaxially mounted on the feed roller shaft in order to monitor the angular rotation of the feed roller.

The motor that powers the paper advance rollers is not shown in FIG. 10, but a hole 310 at the right side of the printing mechanism 306 is where the motor gear (not shown) protrudes through in order to engage a feed roller gear 311, as well as the gear for the discharge roller (not shown). For normal paper pick-up and feeding, it is desired that all rollers rotate in a forward rotation direction 313.

Toward the left side of the printing mechanism 307, in the example of FIG. 10, is a maintenance station 330. The maintenance station 330 includes a cap 332 for capping the printhead 250 when it is not in use, and a wiper 334 for wiping excess ink and other debris from the nozzle face of the printhead 250. The cap 332 typically has an elastomeric member that seals against the nozzle face of the printhead 250 to inhibit the evaporation of carrier fluid such as water from the nozzles when the printer is idle. Maintenance drops are typically ejected into the cap 332 after unsealing the cap 332 and also as needed during printing operations in order to keep the ejectors in suitable condition for firing. In some printers a spittoon (not shown) is provided at the opposite side of the printer from the cap 332. The spittoon is an additional reservoir for receiving ejected maintenance drops, so that whether the printhead is on the left side of the printer or the right side of the printer it has a place outside the printing region to eject maintenance drops. For inks with poor to fair latency, it can be necessary to eject maintenance drops every two to three seconds to keep all ejectors in proper jetting condition. In order to reduce the impact of ejecting maintenance drops on printing throughput, it is desired to extend the time interval between times of firing maintenance drops. Using the printhead 250 having dual feed thermal inkjet ejectors rather than conventional single feed thermal inkjet ejectors, the time interval between firing maintenance drops can be extended significantly so that the waiting time interval can be greater than 10 seconds, or greater than 20 seconds, or greater than one minute or even longer, depending upon the ink properties and operating conditions of the printer. The controller 14 (FIG. 1) is used to control the ejection of ink drops from the printhead 250 for both printing and for maintenance. The controller 14 includes instructions for ejection of maintenance ink drops prior to and following a printing operation (and optionally during a printing option if needed). Typically, during each maintenance-ejection operation, between 5 and 20 maintenance drops are ejected from each dual feed thermal inkjet ejector in the array.

Toward the rear of the printing mechanism 309, in this example, is located the electronics board 390, which includes cable connectors 392 for communicating via cables (not shown) to the printhead carriage 200 and from there to the printhead 250. Also on the electronics board 390 are typically mounted motor controllers for the carriage motor 380 and for the paper advance motor, a clock for measuring elapsed time, a processor and other control electronics (shown schematically as the controller 14 in FIG. 1) for controlling the printing process, and an optional connector for a cable to a host computer.

Printing with a printhead having dual feed thermal inkjet ejectors can be particularly advantageous in a wide format carriage printer (not shown). Desktop carriage printers, such as the example shown in FIG. 10 are compatible with paper widths of greater than 8.0 inches (e.g. letter size or A4 size paper) along the carriage scan direction 305. Wide format printers are typically compatible with paper widths of greater than 20 inches or 40 inches or even 60 inches (depending on the model) along the carriage scan direction. As a result, the time interval between successive occasions of reaching the cap or spittoon for ejecting maintenance drops can be significantly longer than in a desktop carriage printer. Generically a wide format has similar subsystems as a desktop carriage printer, although the specifics can be different. For example, while desktop carriage printers are typically sheet-fed as described above relative to FIG. 11, wide format printers can be either sheet fed or recording medium can be advanced from an input roll to a position near the printhead for printing.

Having described typical inkjet printing systems with a printhead having dual feed thermal inkjet ejectors, a context has been provided for describing a method of printing an image using inks that tend to have latencies that typically require frequent maintenance ejection operations when using a printhead having conventional single feed thermal inkjet ejectors. The method of printing an image on a recording medium includes supplying a pigmented ink to an inkjet printhead having an array of dual feed thermal inkjet ejectors, where the pigmented ink includes an aqueous carrier with a pigment particle loading of at least 4 percent by weight and a polymer loading of at least 1 percent by weight; ejecting a plurality of maintenance drops of the pigmented ink from the array of dual feed thermal inkjet ejectors prior to a start of printing the image on the recording medium; printing the image swath by swath by ejecting printing drops of the pigmented ink on the recording medium as a carriage moves the printhead back and forth in a carriage scan direction across the recording medium between successive advances of the recording medium, such that a plurality of printing swaths are required in order to complete the printing of the image; and ejecting a plurality of maintenance drops of the pigmented ink from the array of dual feed thermal inkjet ejectors after a completion of printing the image on the recording medium, where no maintenance drops are ejected between the start and the completion of the printing of the image.

A plurality of printing swaths are specified above in the method of printing because for some images, such as a title page document, the entire document can be printed in a single swath without requiring maintenance drops being ejected between the start and the completion of the printing of the image even with conventional single feed thermal inkjet ejectors and latency-challenged inks because the printing time is so short. What the dual feed thermal inkjet ejectors can enable for such latency-challenged inks is a time interval of greater than or equal to 10 seconds, or even greater than or equal to 20 seconds between ejecting the plurality of maintenance drops prior to the start of printing the image and ejecting the plurality of maintenance drops after the completing of the image. In this way, even time consuming prints, such as large documents or high quality photographic images printed in multiple passes, can be printed without stopping to eject maintenance drops between swaths of printing.

In some instances, the latency time using a printhead with dual feed thermal inkjet and latency-challenged inks can be sufficiently long that it is not necessary to eject maintenance drops after the end of each sheet of recording medium. Instead, after discharging the first sheet of recording medium after the completion of printing a first image, a second sheet of recording medium can be advanced to a position near the inkjet printhead and a second image can be printed swath by swath on the second sheet as the carriage moves the printhead back and forth in the carriage scan direction across the second sheet between successive advances of the second sheet, such that ejection of maintenance drops is not done immediately following printing the first image on the second sheet, but rather occurs after the printing of the second image on the second sheet. In some cases, several sheets can be printed before it is required to move the printhead to the cap or spittoon to eject maintenance drops, thereby further improving printing throughput.

In addition to improving printing throughput there are other advantages to the improved latency performance using a printhead with dual feed thermal inkjet ejectors. Because fewer maintenance drops are required, there is less ink that is invested in maintenance and more that is available for printing, thereby making the printing system more cost efficient. Also, because there is less ink ejected into the cap or spittoon, there is less ink to accommodate in a waste pad. This is true of both the volatile components that are subsequently evaporated and the solids content that can accumulate and interfere with efficient dispersion of ink from subsequent maintenance operations.

The invention has been described with reference to a preferred embodiment. However, it will be appreciated that variations and modifications can be effected by a person of ordinary skill in the art without departing from the scope of the invention.

### PARTS LIST

5-5 Line
10 Liquid ejection system
12 Data source
14 Controller
16 Electrical pulse source
18 Liquid ejection printhead die
20 Dual feed liquid ejector
24 Recording medium
26 Walls
28 Substrate
30 Chamber
30a Individual Chamber
30b Individual Chamber
30c Individual Chamber
30d Individual Chamber
31 Nozzle plate
32 Nozzle orifice
33 Resistive material
34 Resistive heating element
35 Conductive shorting bar
36 Segmented liquid inlet
37 First segment
37a first segment
38 First liquid feed channel
38a First liquid feed channel
38b First liquid feed channel
38c First liquid feed channel
38d First liquid feed channel
39 Second segment
39a Second segment

### PARTS LIST (CON'T)

39b Second segment
40 Second liquid feed channel
40a Second liquid feed channel
40b Second liquid feed channel
40c Second liquid feed channel
40d Second liquid feed channel
41 Filter post
42 Liquid flow arrows
44 Liquid flow arrows
46 ends
48 ends
50 Line relative to first and second segment ends
52 Post
52a Post
52b Post
54 Indirect liquid supply X
56 Electrical leads
58 Printhead die edge
58a edge
59b edge
200 Carriage
250 Printhead
251 Printhead die
253 Nozzle array
254 Nozzle array direction
256 Encapsulant
257 Flex circuit
258 Connector board
262 Multi-chamber ink supply
264 Single-chamber ink supply

### PARTS LIST (CON'T)

300 Printing mechanism
301 Printing apparatus
302 Paper load entry direction
303 Print region
304 Media advance direction
305 Carriage scan direction
306 Right side of printing mechanism
307 Left side of printing mechanism
308 Front of printing mechanism
309 Rear of printing mechanism
310 Hole (for paper advance motor drive gear)
311 Feed roller gear
312 Feed roller
313 Forward rotation direction (of feed roller)
320 Pick-up roller
322 Turn roller
323 Idler roller
324 Discharge roller
325 Star wheel(s)
330 Maintenance station
332 Cap
334 Wiper
370 Stack of media
371 Top piece of medium
380 Carriage motor
382 Carriage guide rail
383 Encoder fence
384 Belt
390 Printer electronics board
392 Cable connectors

1. A liquid ejection system comprising:
a liquid ejector comprising:
a structure defining a chamber, the chamber including a first surface and a second surface, the first surface including a nozzle orifice;
a resistive heater located on the second surface of the chamber opposite the nozzle orifice;
a first liquid feed channel and a second liquid feed channel is in fluid communication with the chamber; and
a segmented liquid inlet, a first segment of the liquid inlet is in fluid communication with the first liquid feed channel, and a second segment of the liquid inlet is in fluid communication with the second liquid feed channel; and
a liquid supply comprising:
a liquid including a carrier fluid and a solids content that is greater than 5 percent by weight, wherein the liquid supply is fluidically connected to the segmented liquid inlet.

2. The liquid ejection system of claim 1, wherein the solids content is greater than 6 percent by weight.

3. The liquid ejection system of claim 1, wherein the solids content is greater than 8 percent by weight.

4. The liquid ejection system of claim 1, wherein the solids content is greater than 10 percent by weight.

5. The liquid ejection system of claim 1, wherein the liquid further includes a pigment particle loading of at least 4 percent by weight.

6. The liquid ejection system of claim 5, wherein the liquid further includes a dispersant polymer loading of at least 10 percent of the pigment loading by weight.

7. The liquid ejection system of claim 5, wherein the liquid further includes a binder polymer loading of at least 1 percent by weight.

8. The liquid ejection system of claim 7, wherein the binder polymer has a molecular weight of between 15,000 and about 150,000.

9. The liquid ejection system of claim 7, wherein the binder polymer has an acid number of at least 50.

10. The liquid ejection system of claim 1, wherein the liquid further includes a viscosity of between about 2 and 10 centipoise.

11. The liquid ejection system of claim 1, wherein the liquid further includes:
a conductive particle loading of at least 4 percent by weight; and
a polymer loading of at least 1 percent by weight.

12. The liquid ejection system of claim 1, wherein the liquid ejector is able to consistently eject a drop of the liquid after a waiting time of at least 10 seconds since a most recent previously ejected drop of the liquid.

13. An inkjet printing system comprising:
an inkjet printhead comprising a thermal inkjet ejector including:
a structure defining a chamber, the chamber including a first surface and a second surface, the first surface including a nozzle orifice;
a resistive heater located on the second surface of the chamber opposite the nozzle orifice;
a first ink feed channel and a second ink feed channel is in fluid communication with the chamber; and
a segmented ink inlet, a first segment of the ink inlet is in fluid communication with the first ink feed channel, and a second segment of the ink inlet is in fluid communication with the second ink feed channel; and
an ink supply comprising an ink including:
an aqueous carrier;
a dispersion of pigmented particles; and
at least one polymer, wherein a solids content including the pigmented particles and the at least one polymer is greater than 5 percent by weight, wherein the ink supply is fluidically connected to the segmented ink inlet;
a media advance system for advancing recording medium to a position proximate the inkjet printhead for printing; and
a controller for controlling of ejection of ink drops from the inkjet printhead for printing and for maintenance.

14. The inkjet printing system of claim 13, wherein the controller includes instructions for ejection of maintenance ink drops prior to and following a printing operation, such that a time interval between the ejection of maintenance drops prior to the printing operation and the ejection of maintenance drops following the printing operation is greater than 10 seconds.

15. The inkjet printing system of claim 14, wherein the time interval between the ejection of maintenance drops prior to the printing operation and the ejection of maintenance drops following the printing operation is greater than 20 seconds.

16. The inkjet printing system of claim 13, further comprising a reservoir into which the maintenance drops are ejected.

17. The inkjet printing system of claim 13, wherein the at least one polymer in the ink includes a binder polymer having a molecular weight between 15,000 and 150,000.

18. The inkjet printing system of claim 17, wherein the binder polymer has an acid number of at least 50.

19. The inkjet printing system of claim 13, wherein the at least one polymer ink includes a polymeric dispersant for the pigment particles having a weight average molecular weight less than about 15,000.

20. The inkjet printing system of claim 13, wherein the ink in the ink supply has a viscosity between about 2 and 10 centipoise.

21. The inkjet printing system of claim 13, wherein the ink further includes glycerol and a 1,2-alkanediol having from four to eight carbon atoms.

22. The inkjet printing system of claim 13, wherein the solids content of the ink is greater than 6 percent by weight.

23. The inkjet printing system of claim 13, wherein the solids content of the ink is greater than 8 percent by weight.

24. The inkjet printing system of claim 13, wherein the solids content of the ink is greater than 10 percent by weight.

25. The inkjet printing system of claim 13, wherein the pigment particle loading of the ink is at least 4 percent by weight.

26. The inkjet printing system of claim 13, wherein the ink further includes at least 0.5 percent by weight of a branched, polyethylene glycol ether.

27. The inkjet printing system of claim 26, wherein the pigment particle loading of the ink is at least 4 percent by weight.

28. The inkjet printing system of claim 26, wherein the at least one polymer in the ink includes a binder polymer having a molecular weight between 15,000 and 150,000.

29. The inkjet printing system of claim 13, wherein the ink further includes at least 2 percent by weight of a branched, polyethylene glycol ether.

30. The inkjet printing system of claim 13, wherein the ink further includes at least 4.0 percent by weight of a branched, polyethylene glycol ether.
